(19) United States
(12) Patent Application Publication
(10) Pub. No.: US 2024/0367453 A1
(43) Pub. Date: Nov. 7, 2024

(54) CARD FOR RETAINING INSERT SHEET

(71) Applicant: HALLMARK CARDS, INCORPORATED, KANSAS CITY, MO (US)

(72) Inventors: ORLANDA DOMINIC LACY, KANSAS CITY, MO (US); RACHEL KARACA SLEETER, KANSAS CITY, MO (US)

(21) Appl. No.: 18/655,804

(22) Filed: May 6, 2024

Related U.S. Application Data
(60) Provisional application No. 63/463,930, filed on May 4, 2023.
(60) Provisional application No. 63/526,663, filed on Jul. 13, 2023.

(51) Int. Cl. B42D 15/04

(52) U.S. Cl. CPC B42D 15/045

(57) ABSTRACT

A greeting card for retaining an insert sheet bearing a customized or personalized message is disclosed. In one embodiment, the card includes notch(es) formed in a card panel for retaining the insert sheet at a predetermined location on the panel. In another embodiment, the card includes a partial pocket attached to a card panel for retaining a portion of the insert sheet inside the pocket. In another embodiment, the card includes a frame formed in a card panel that is configured to retain the insert sheet between the frame and another card panel. In yet another embodiment, the card includes two card panels configured to form a hidden pocket for retaining the insert sheet inside the pocket. In yet other embodiments, a greeting card and envelope assembly is provided.

### CROSS-REFERENCE TO RELATED APPLICATIONS

This application is based on and claims priority to U.S. Provisional Application Ser. No. 63/463,930, filed on May 4, 2023, and U.S. Provisional Application Ser. No. 63/526,663, filed on Jul. 13, 2023, each of which is incorporated herein by reference in its entirety.

### BACKGROUND OF THE INVENTION

Various online ordering systems enable a consumer to order a product for delivery to a designated recipient. Some of these systems enable the consumer to indicate that the ordered product is a gift, in which case the consumer may enter a personalized message for the designated recipient. This personalized message is typically printed on a paper receipt or packing slip that is enclosed in the box or other packaging used to deliver the product to the designated recipient. This paper receipt or packing slip does not have a pleasing or stylish appearance and is not ideal for presenting the personalized message to the recipient. In addition, some recipients disregard or simply do not notice paper materials enclosed in the packaging and, thus, do not even read the personalized message printed on the paper receipt or packing slip.

### BRIEF SUMMARY OF THE INVENTION

The present invention is directed to a greeting card configured to retain an insert sheet bearing a personalized or customized message intended for the card recipient. Various greeting card embodiments with formats that enable the retention of the insert sheet are disclosed herein.

In some embodiments, the greeting card has a notched format in which one or more notches formed in a card panel are configured to releasably retain corner and/or edge portions of an insert sheet at a predetermined location on the panel. In other embodiments, the greeting card has a partial pocket format in which a partial pocket attached to a card panel is configured to releasably retain a portion of the insert sheet inside the partial pocket. In other embodiments, the greeting card has a frame format in which a frame formed in a card panel is configured to releasably retain the insert sheet between the frame panel and another card panel. In yet other embodiments, the greeting card has a hidden pocket format in which two card panels are configured to form a hidden pocket for releasably retaining the insert sheet inside the hidden pocket. In all of these embodiments, the personalized or customized message may be printed on the insert sheet prior to placement in the card.

In some embodiments, the greeting card is provided as part of a greeting card and envelope assembly. In one aspect, the greeting card is integrally formed with the envelope so as to provide a one-piece greeting card and envelope assembly. In another aspect, the greeting card and envelope are separate components so as to provide a two-piece greeting card and envelope assembly. The greeting card of the greeting card and envelope assembly may have a notched format, a partial pocket format, a frame format, or a hidden pocket format, as described herein.

In some embodiments, the greeting card (with the retained insert sheet)—whether provided by itself or as part of a greeting card and envelope assembly—is placed in a protective sleeve. In one aspect, the protective sleeve containing the greeting card or greeting card and envelope assembly is dropped in a package for delivery. In another aspect, a bottom edge of the protective sleeve is opened to enable the greeting card or greeting card and envelope assembly to pass through the bottom edge and drop into a package for delivery.

The greeting card and retained insert sheet of the present invention overcomes many of the drawbacks of existing paper receipts and packing slips, including: (1) the personalized or customized message is presented on a card having a pleasing and stylish appearance; and (2) the card is more likely to be noticed and read by the card recipient compared to a paper receipt or packing slip. Further, the process of inserting the insert sheet into the card can be quickly and easily performed at an existing packing station of a fulfillment center.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various embodiments of the present invention is provided below with reference to the following drawings, in which:

FIG. 1 is a plan view of an exemplary greeting card that may be configured to retain an insert sheet;

FIG. 2 is a plan view of an exemplary insert sheet that may be retained in a greeting card;

FIGS. 3A-3G are plan views of greeting cards with a notched format in which one or more notches are formed in a card panel for releasably retaining corner and/or edge portions of an insert sheet;

FIGS. 4A-4E are plan views of greeting cards with a partial pocket format in which a partial pocket is attached to a card panel for releasably retaining a lower portion of an insert sheet in the partial pocket;

FIG. 5 is a plan view of a greeting card with a partial pocket format in which a partial pocket is attached to a card panel for releasably retaining a side portion of an insert sheet in the partial pocket;

FIGS. 6A-6B are plan views of a greeting card with a frame format in which a frame is formed in a card panel for releasably retaining an insert sheet between the frame and another card panel;

FIGS. 7A-7B are plan views of a greeting card with a hidden pocket format in which two card panels form a hidden pocket that is accessed from the right side of the panels for releasably retaining an insert sheet in the hidden pocket;

FIGS. 8A-8B are plan views of a greeting card with a hidden pocket format in which two card panels form a hidden pocket that is accessed from the left side of the panels for releasably retaining an insert sheet in the hidden pocket;

FIGS. 9A-9F are plan views of a one-piece greeting card and envelope assembly contained within a protective sleeve, wherein the greeting card has a frame format in which a frame is formed in a card panel for releasably retaining an insert sheet between the frame panel and another card panel;

FIGS. 10A-10D illustrate a method of top-loading the insert sheet into the frame of the greeting card shown in FIGS. 9A-9F and then opening the bottom edge of the protective sleeve to enable the card and envelope assembly with the retained insert sheet to pass through the bottom edge and drop into a package for delivery;

FIGS. 11A-11G are plan views of a two-piece greeting card and envelope assembly contained within a protective sleeve, wherein the greeting card has a frame format in which a frame is formed in a card panel for releasably retaining an insert sheet between the frame panel and another card panel; and

FIGS. 12A-12D illustrate a method of top-loading the insert sheet into the frame of the greeting card shown in FIGS. 11A-11G and then opening the bottom edge of the protective sleeve to enable the card and envelope assembly with the retained insert sheet to pass through the bottom edge and drop into a package for delivery.

### DETAILED DESCRIPTION OF EMBODIMENTS

The present invention is directed to a greeting card configured to retain an insert sheet bearing a personalized or customized message intended for the card recipient. While the invention will be described in detail below with reference to various exemplary embodiments, it should be understood that the invention is not limited to the specific system configurations or methods of these embodiments. In addition, although the exemplary embodiments are described as embodying several different inventive features, one skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

The greeting cards described below may be used in a variety of implementations. For example, the greeting card with the retained insert sheet—either by itself or provided as part of a card and envelope assembly—may be placed in a box or other packaging used to deliver one or more products to a gift recipient. In this case, the greeting card and insert sheet may be handled by a worker at a packing station of a fulfillment center. The greeting card may be provided in a protective sleeve, thereby protecting the card surface from being soiled by environmental and hygiene factors (e.g., dirt, grime, etc.) due to handling at the fulfillment center. As such, the greeting card is protected until it is placed into a package for delivery with the rest of the items in an order. The greeting card with the retained insert sheet may also be inserted into an envelope and delivered to a gift recipient as a standalone product—either with or without a gift card, etc. Of course, other implementations will be apparent to one skilled in the art.

### General Configuration of Greeting Card and Insert Sheet

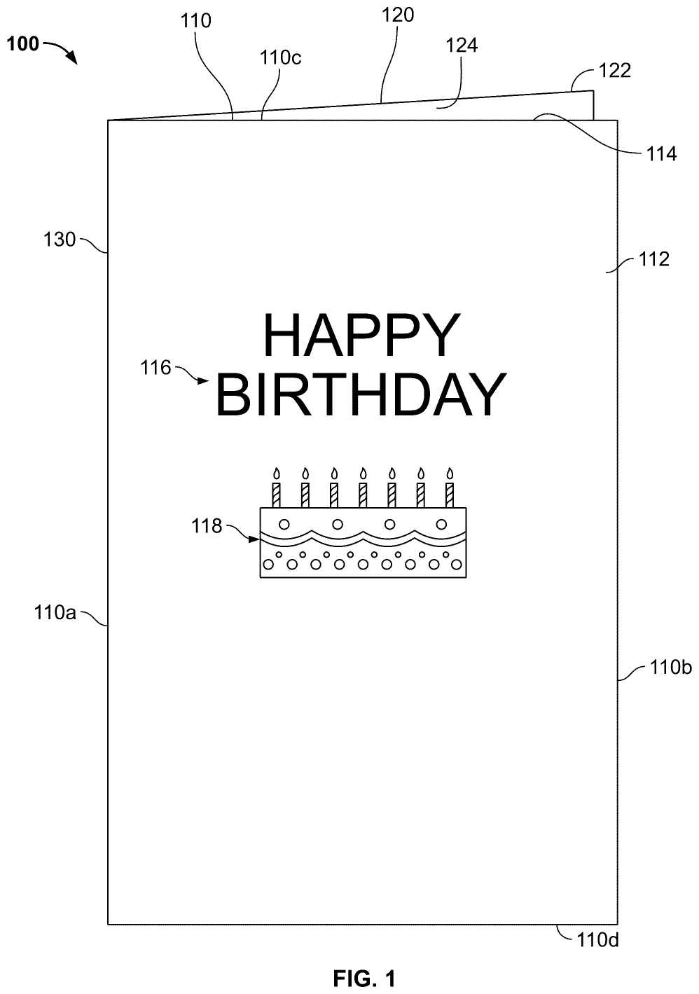

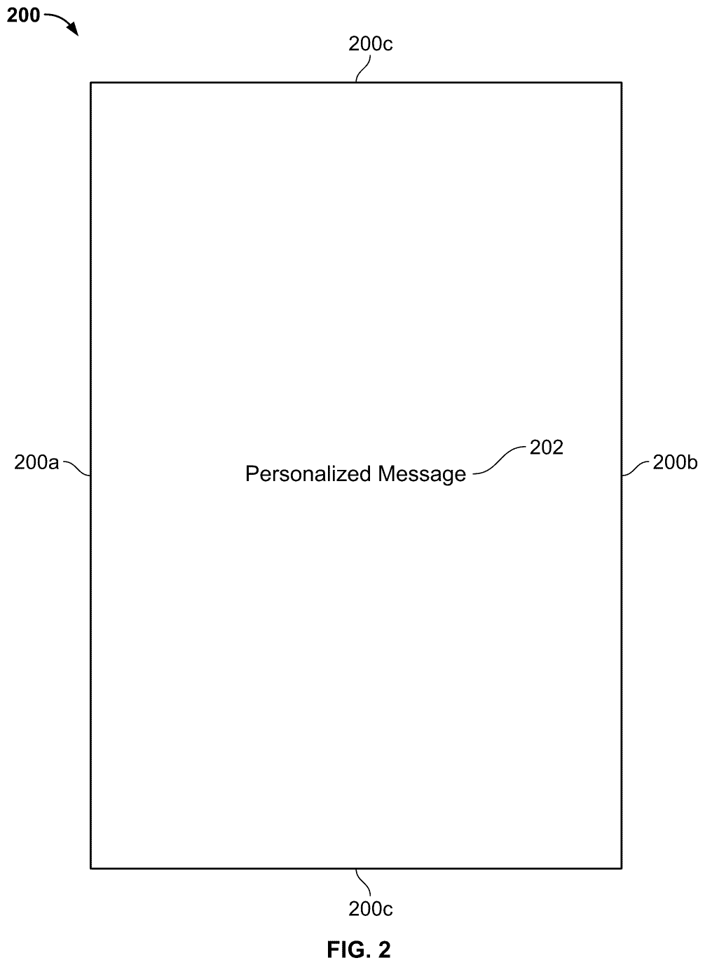

FIG. 1 depicts an exemplary greeting card 100 that may be configured to retain an insert sheet (such as the insert sheet 200 shown in FIG. 2, described below) in accordance with embodiments of the present invention. Greeting card 100 includes two card panels—a front panel 110 and a back panel 120—which are movable relative to each other along a fold line 130. Fold line 130 may comprise a crease score, a cut score, or any other type of fold line known in the art. Fold line 130 enables greeting card 100 to be moved between a closed position, as shown in FIG. 1, and an opened position to reveal the inside of the card.

In this embodiment, front panel 110 has a substantially rectangular shape defined by substantially parallel side edges 110a and 110b (i.e., the major edges in this embodiment) and substantially parallel top and bottom edges 110c and 110d (i.e., the minor edges in this embodiment). Side edges 110a and 110b are substantially parallel to fold line 130 and top and bottom edges 110c and 110d are substantially perpendicular to fold line 130. Front panel 110 has an outside face 112 and an inside face 114. Outside face 112 includes pre-printed text 116 positioned above a pre-printed image 118, which is referred to as the “FRONT” of the front panel in various drawings submitted herewith. Of course, other greeting cards may include other design elements, such as text, images, graphics, or other decorative features, which are printed on and/or secured to the outside and/or inside faces of the front panel.

Back panel 120 also has a substantially rectangular shape defined by substantially parallel side edges (i.e., the major edges in this embodiment) and substantially parallel top and bottom edges (i.e., the minor edges in this embodiment). Thus, the side edges are substantially parallel to fold line 130 and the top and bottom edges are substantially perpendicular to fold line 130. Back panel 120 has an outside face 122 and an inside face 124. Outside face 122 includes pre-printed text, such as the name and/or logo of the company that manufactured the greeting card, which is referred to as the “LOGO SIDE” of the back panel in various drawings submitted herewith. Of course, other information may be printed on the outside and/or inside faces of the back panel.

Greeting card 100 also includes retention means (not shown in FIG. 1) configured to retain an insert sheet in the card. Various types of retention means will be described in greater detail below, some of which are configured for use with a two-panel card, such as greeting card 100, while others are configured for use with a three-panel card. Of course, the retentions means may also be used with various types of multi-panel cards known in the art. Also, the greeting card may be provided as part of a one-piece or two-piece greeting card and envelope assembly, as disclosed herein.

It should be understood that greeting card 100 is just an exemplary card and that other cards may be configured to retain an insert sheet as described herein. For example, the front and back panels of a card may have other suitable shapes, such as square, oval, circular, or triangular. Also, the major and minor edges of the front and back panels may be at other orientations, e.g., the major edges may be substantially perpendicular to the fold line and the minor edges may be substantially parallel to the fold line. In addition, the card may have less than or greater than two panels—e.g., the greeting card may comprise a postcard-type greeting card having one panel or a greeting card with three or more panels, as noted above. Of course, other greeting card configurations will be apparent to one skilled in the art.

FIG. 2 depicts an exemplary insert sheet 200 that is configured to be retained in a card (such as greeting card 100 shown in FIG. 1) in accordance with an embodiment of the present invention. Insert sheet 200 has a substantially rectangular shape defined by substantially parallel side edges 200a and 200b (i.e., the major edges in this embodiment) and substantially parallel top and bottom edges 200c and 200d (i.e., the minor edges in this embodiment). Insert sheet 200 includes a customized or personalized message 202 that is printed on the outside face of the sheet prior to insertion into a card.

In some embodiments, a personalized message to be printed on an insert sheet is provided by a user, such as the purchaser of a gift. In one embodiment, the purchaser uses a computing device (e.g., mobile phone, computing tablet, personal computer, or laptop computer) to interact with an ordering application and provide an indication that an ordered product is a gift. At that time, the ordering application may enable the purchaser to input a personalized message to be printed on an insert sheet. Optionally, the purchaser may be able to select one or more text attributes for the personalized message, such as the font type for the text (e.g., Times New Roman, etc.), the font style for the text (e.g., regular, italic, bold, etc.), the font size for the text (e.g., 10 point, 12 point, etc.), the font color for the text (e.g., black, red, etc.), and/or the alignment of the text (e.g., align left, center, align right, or justify). The personalized message is then printed on an insert sheet and inserted into a greeting card, as described below. In other embodiments, a customized message that is not created specifically for a sender-recipient is provided on pre-printed inserts. In this case, each customized message may have a “customizable” format with a prescribed set of changeable content for the inserts.

It can be appreciated that the size of the insert sheet will vary depending on the size of the greeting card. In one embodiment, greeting card 100 has a width of approximately 5 inches (i.e., the distance between the side edges of the front and back panels) and a height of approximately 7 inches (i.e., the distance between the top and bottom edges of the front and back panels). By contrast, insert sheet 200 has a width of approximately 4 inches (i.e., the distance between the side edges of the sheet) and a height of approximately 6 inches (i.e., the distance between the top and bottom edges of the sheet). Of course, other card and insert sheet sizes may be used in accordance with the present invention, provided that the width and height of the card is greater than the width and height of the insert sheet, respectively, so that the insert sheet does not extend beyond the edges of the card.

In one embodiment, greeting card 100 is made of a heavier weight paper—e.g., paper having a weight in the range of 59 lb cardstock to 65 lb cardstock. Insert sheet 200 may be made of paper having a thickness that ranges from the thickness of receipt paper to the thickness equivalent to the paper used to make greeting card 100. It can be appreciated that the thickness of the insert sheet will vary depending on the configuration of the card and, in particular, the type of retention means used to retain the insert sheet in the card. For example, cards having a partial pocket format can accommodate insert sheets having a smaller thickness than cards having a notched, frame or hidden pocket format.

### Card Formats and Retention Means

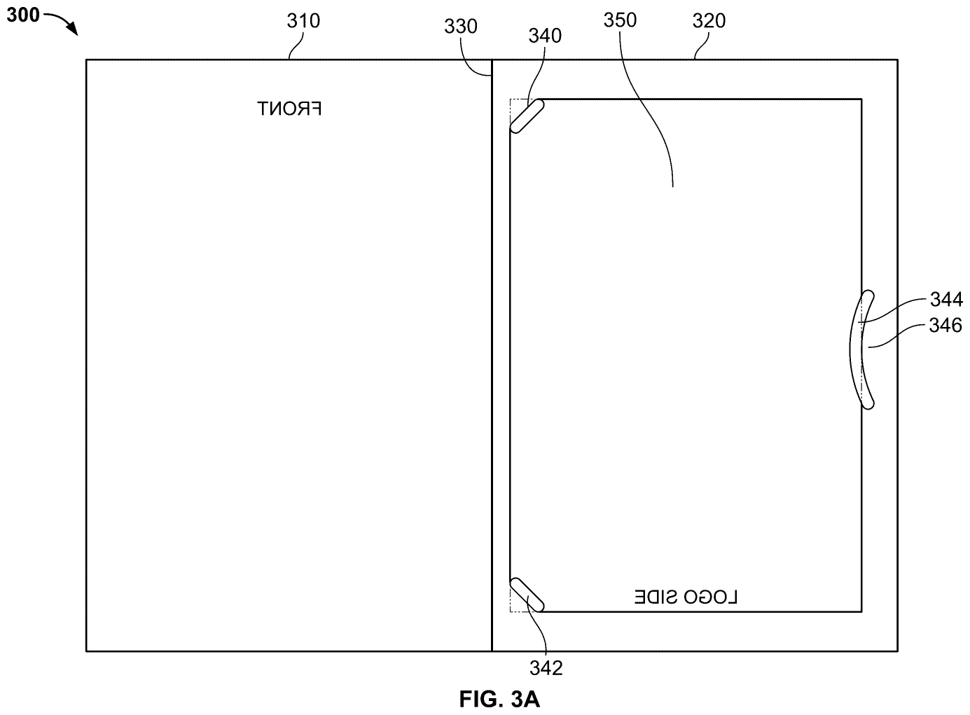

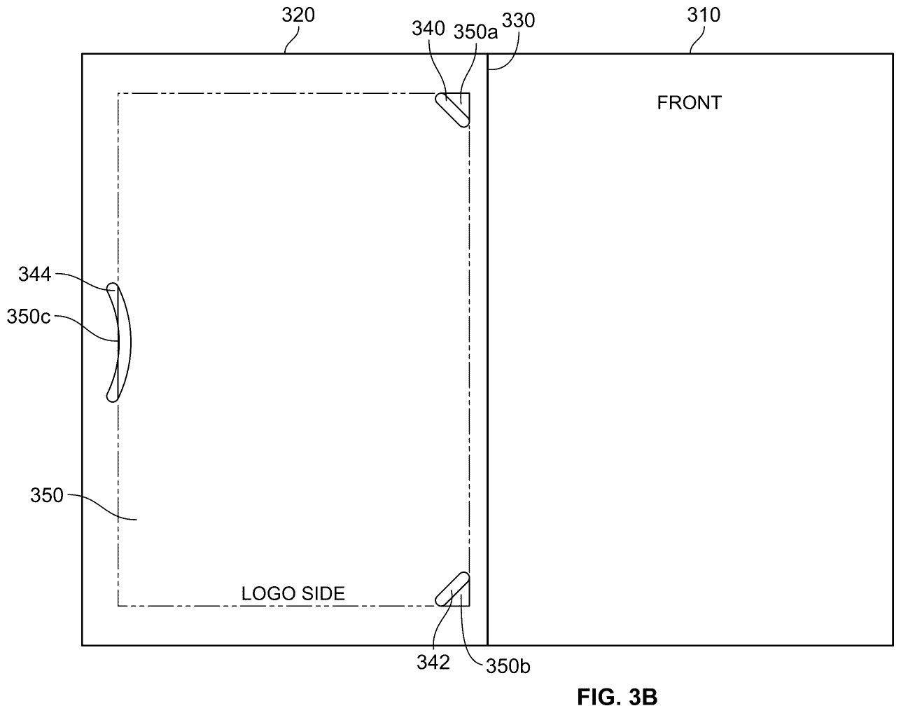

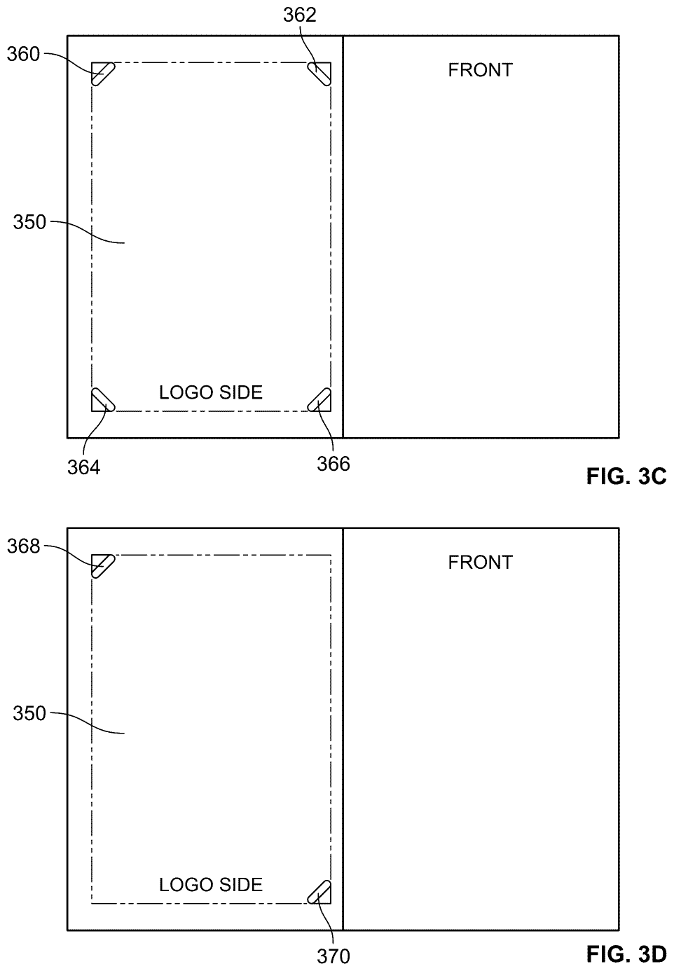

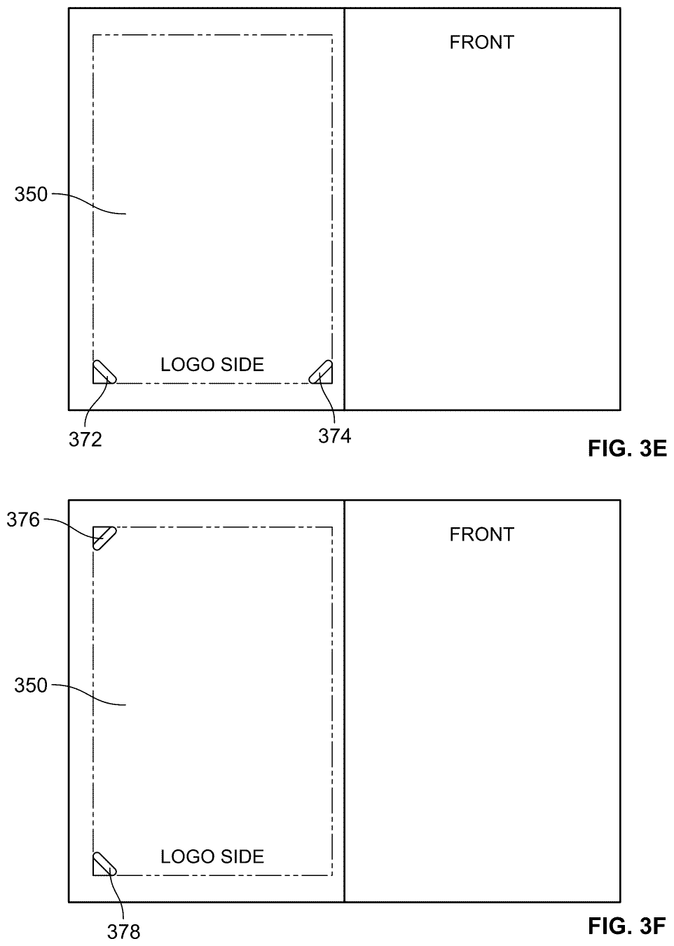

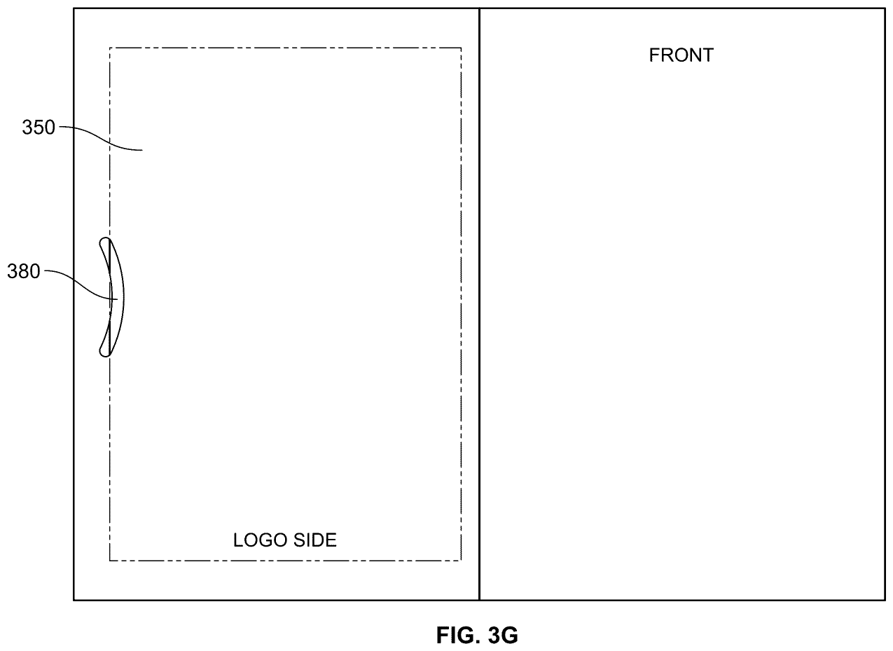

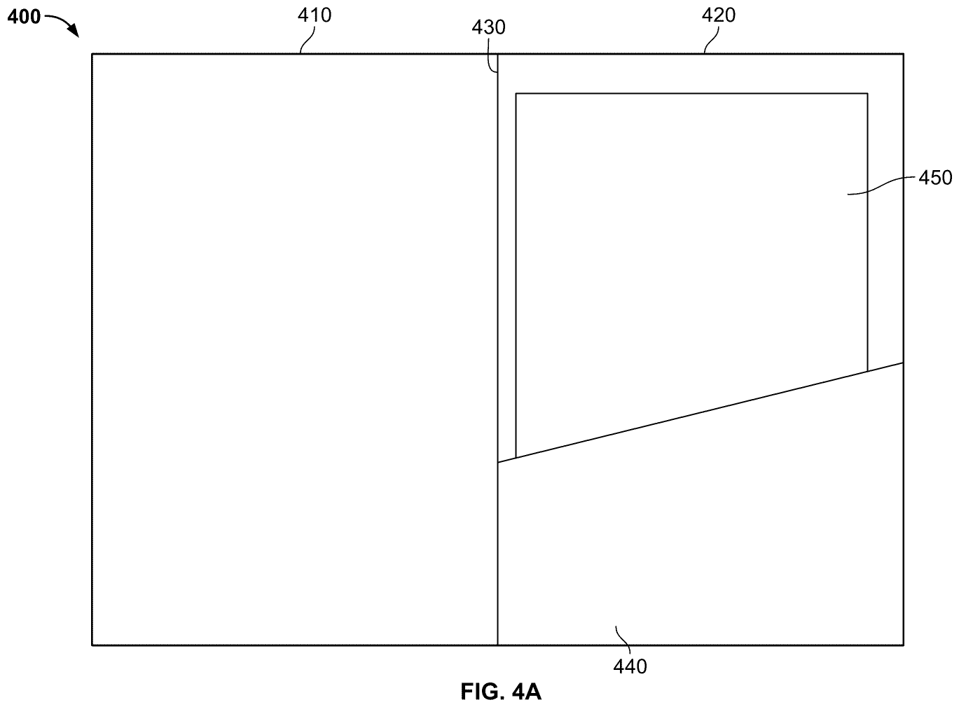

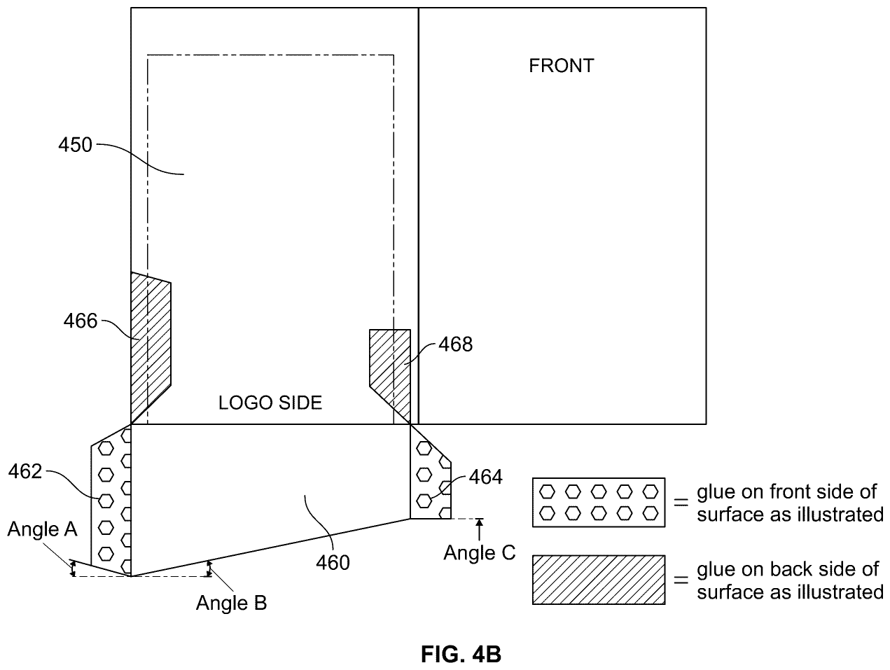

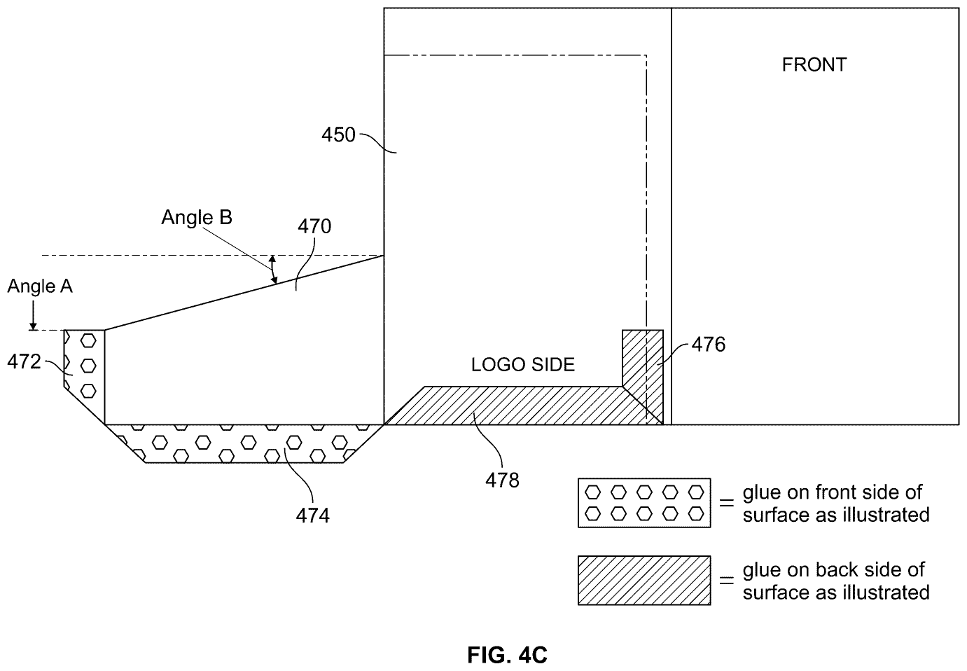

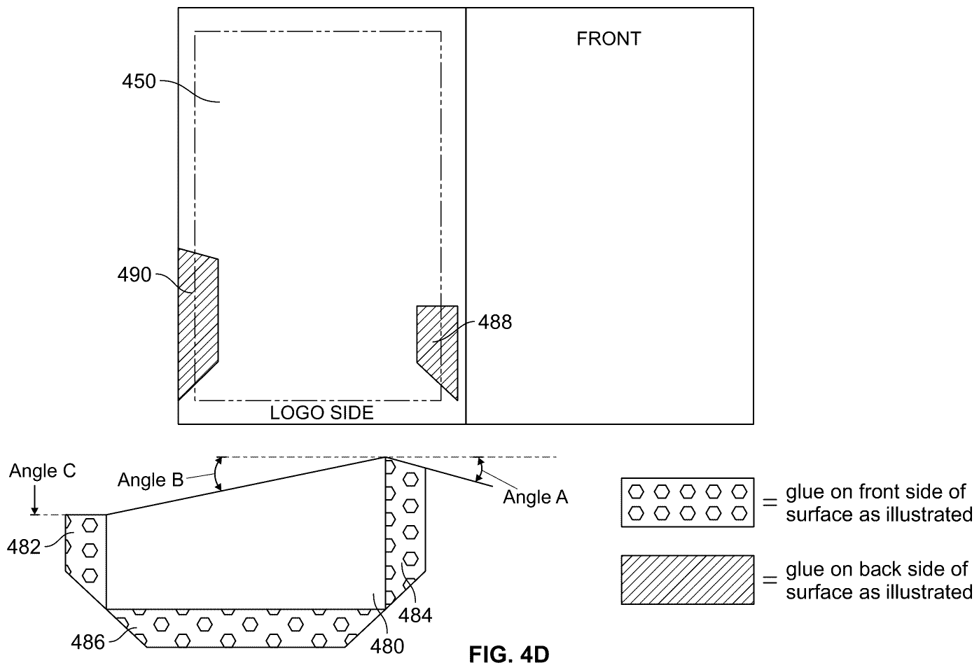

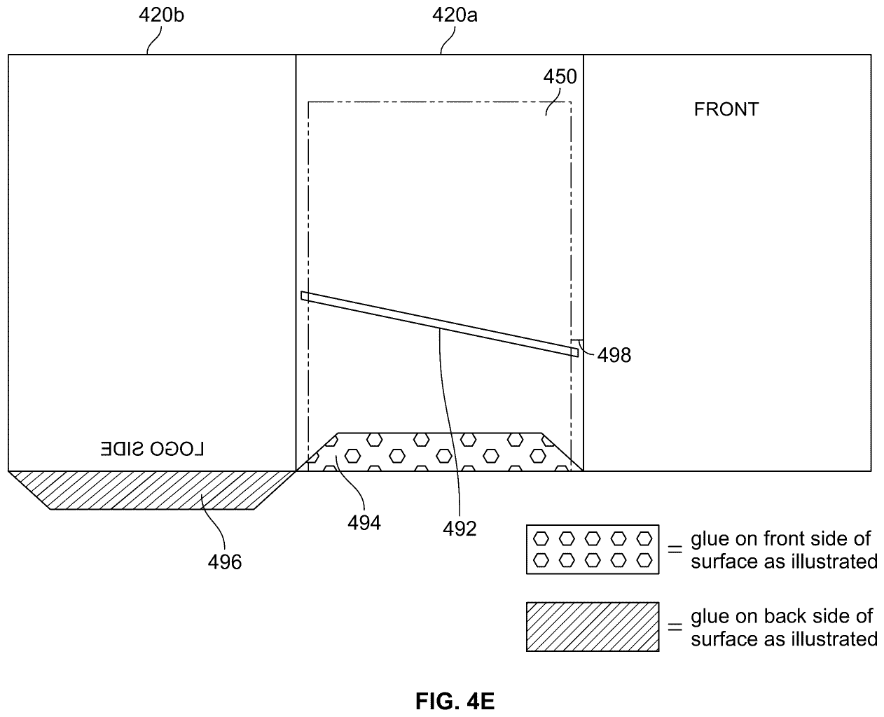

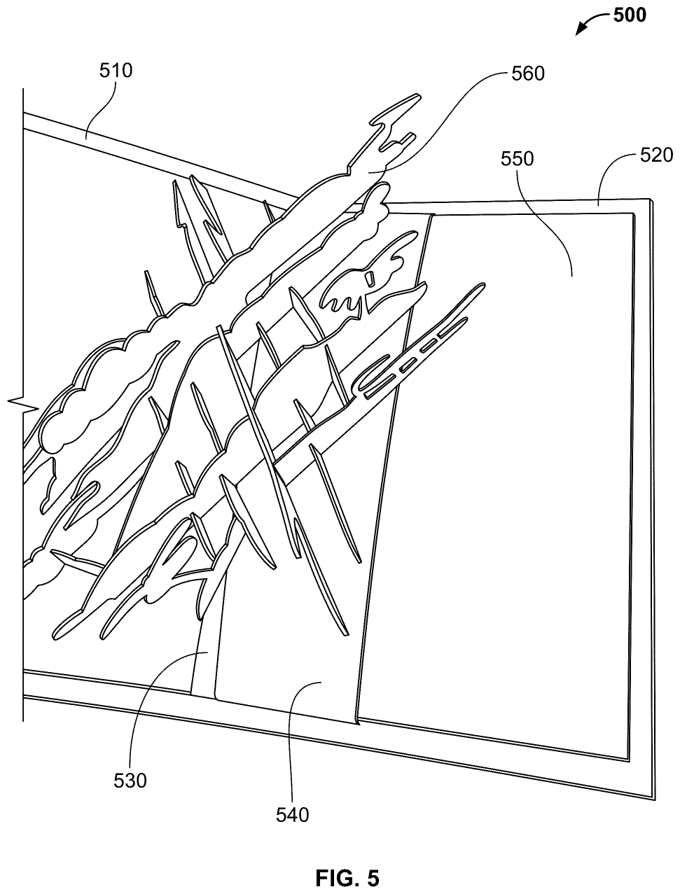

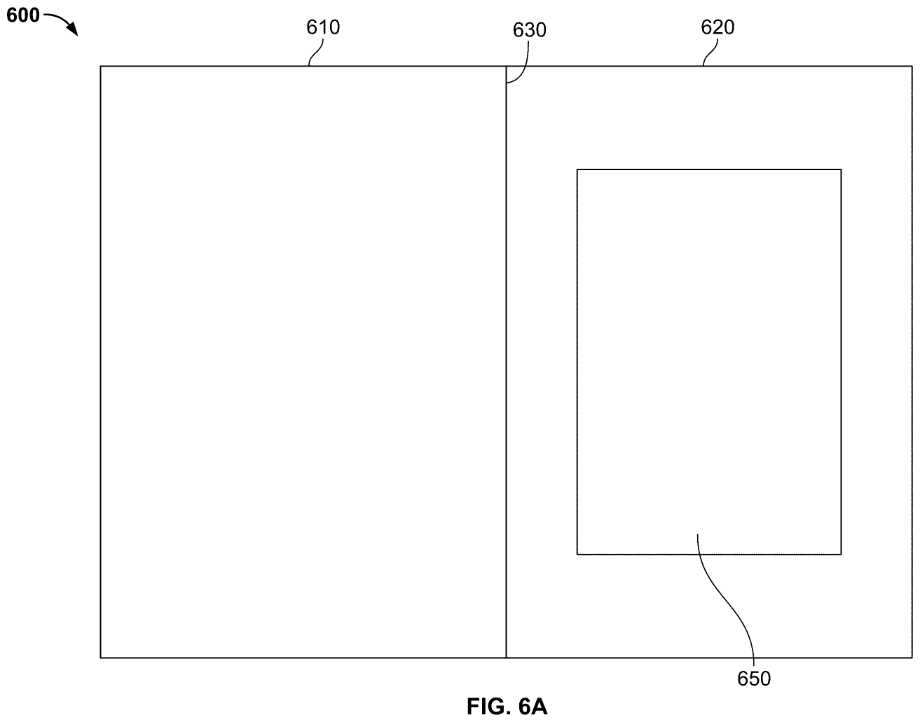

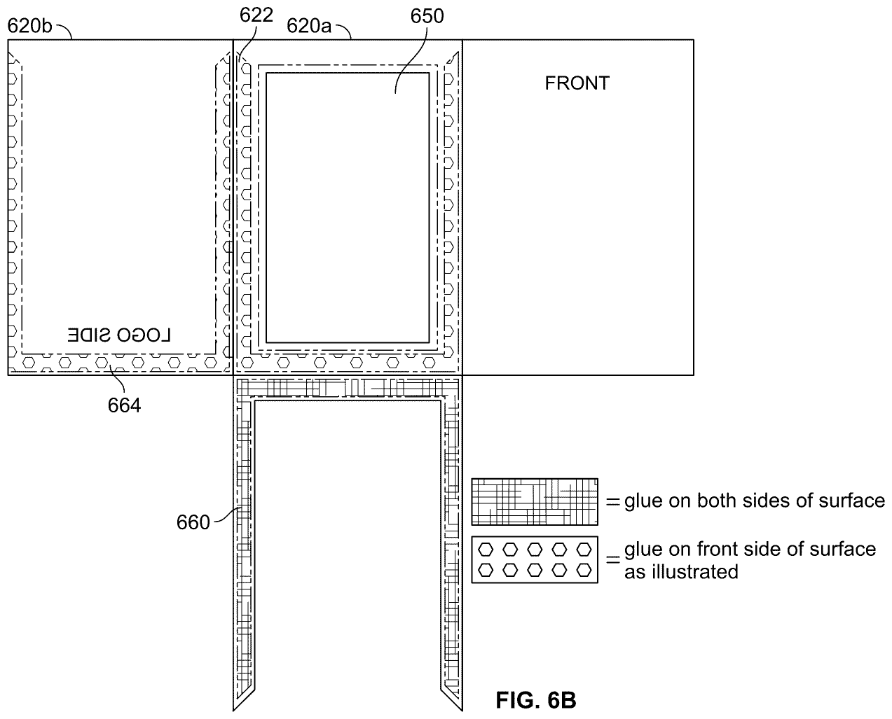

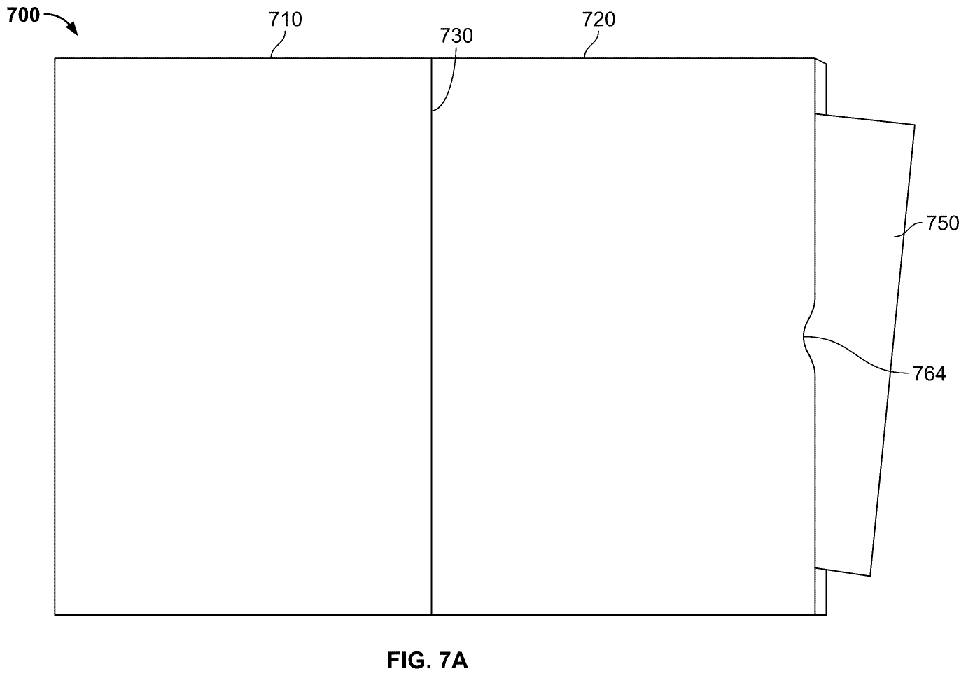

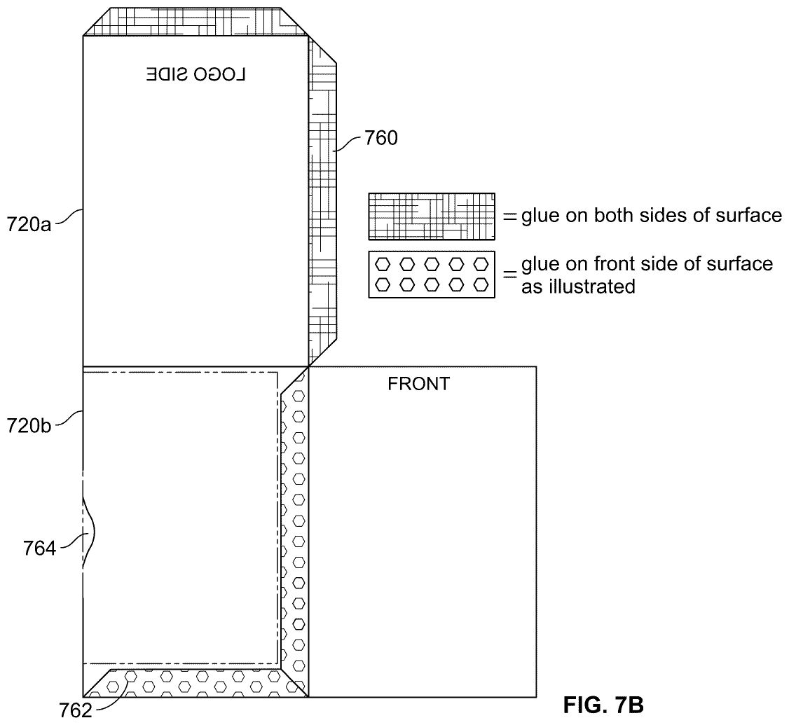

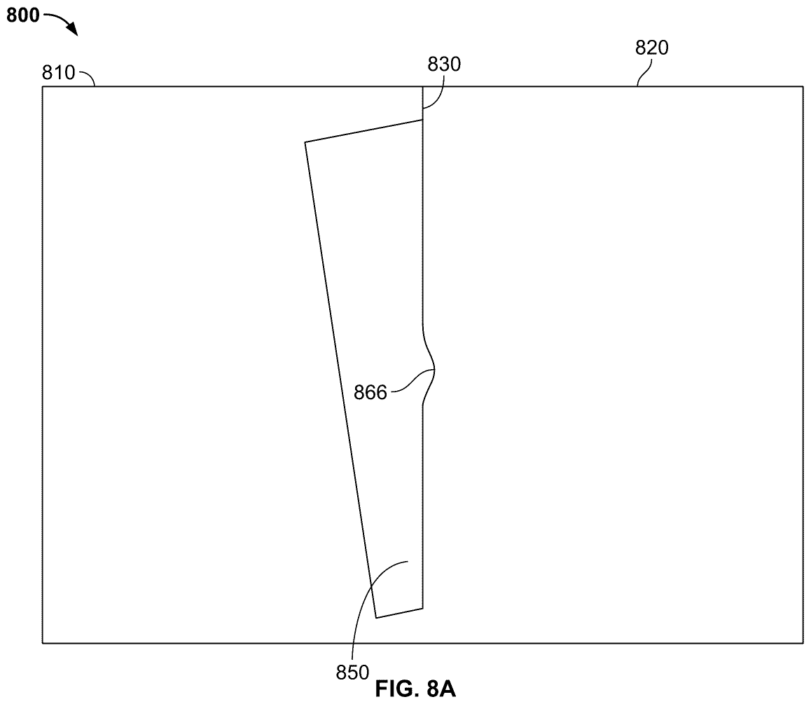

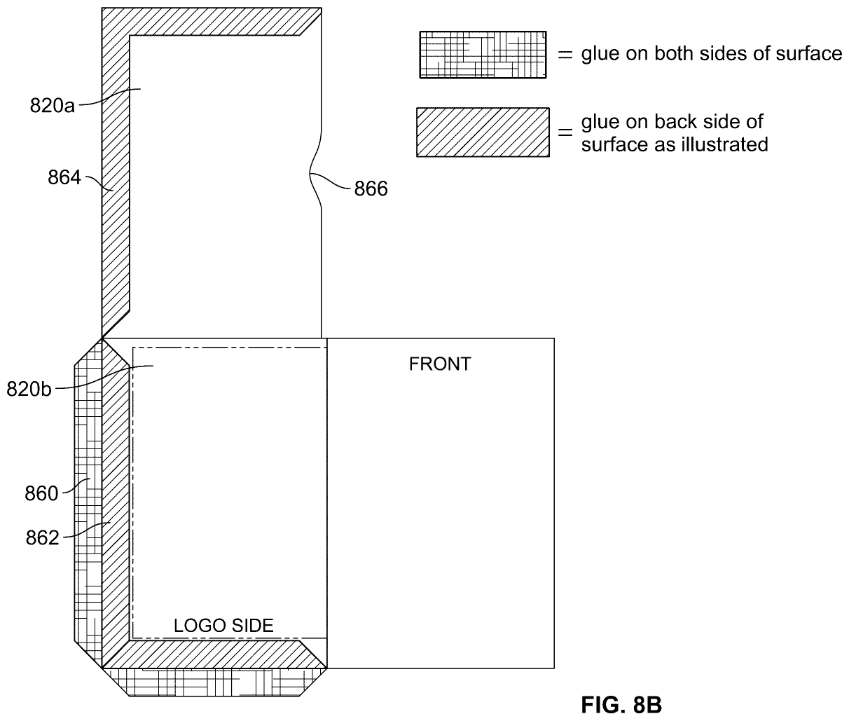

As noted above, the greeting cards of the present invention include retention means for retaining an insert sheet in the card. Various types of retention means will be described below, including: (1) cards with a notched format in which one or more notches formed in a card panel are configured to releasably retain corner and/or edge portions of an insert sheet at a predetermined location on the panel (shown in FIGS. 3A-3G); (2) cards with a partial pocket format in which a partial pocket attached to a card panel is configured to releasably retain a portion of an insert sheet inside the partial pocket (shown in FIGS. 4A-4E and FIG. 5); (3) cards with a frame format in which a frame formed in a card panel is configured to releasably retain an insert sheet between the frame panel and another card panel (shown in FIGS. 6A-6B, 9A-9F, and 11A-11G); and (4) cards with a hidden pocket format in which two card panels form a hidden pocket that is configured to releasably retain an insert sheet inside the hidden pocket (shown in FIGS. 7A-7B and FIGS. 8A-8B). It will be seen that certain retention means may be used with a two-panel card, such as greeting card 100 shown in FIG. 1, while other retention means require the use of a three-panel card. It will also be seen that the greeting card with the retention means may be part of a greeting card and envelope assembly.

In all of the drawings, it should be understood that the portions of the insert sheet that can be seen in a particular view are shown in solid lines, while the portions of the insert sheet that cannot be seen in that view (because the insert sheet is positioned on the opposite face of the card panel) are shown in dashed lines.

Cards with Notched Format

Referring to FIGS. 3A-3G, various embodiments of greeting cards with a notched format are shown. Each of these cards includes one or more notches formed in a card panel for releasably retaining corner and/or edge portions of an insert sheet at a predetermined location on the panel. It will be seen that the number, position and shape of the notches are different between the various embodiments described below.

FIGS. 3A-3B show an embodiment of a greeting card 300 with a front panel 310 and a back panel 320 that are movable relative to each other along a fold line 330—i.e., card 300 has substantially the same configuration as greeting card 100 described above. In FIG. 3A, the card is shown in an opened position with the inside faces of the front and back panels facing upward. Conversely, in FIG. 3B, the card is shown in an opened position with the outside faces of the front and back panels facing upward.

In this embodiment, card 300 includes three notches 340, 342 and 344 formed in back panel 320 for releasably retaining an insert sheet 350 on the inside face of back panel 320.

Notch 340 is formed from a die cut positioned in the upper left corner of back panel 320. Notch 340 comprises an aperture having an oblong shape that is oriented to enable insertion of the upper left corner 350a of insert sheet 350 through notch 340, as shown in FIG. 3B. Thus, when insert sheet 350 is retained on the inside face of back panel 320, the upper left corner 350a of insert sheet 350 extends through notch 340 and contacts the outside face of back panel 320.

Notch 342 is formed from a die cut positioned in the lower left corner of back panel 320. Notch 342 comprises an aperture having an oblong shape that is oriented to enable insertion of the lower left corner 350b of insert sheet 350 through notch 342, as shown in FIG. 3B. Thus, when insert sheet 350 is retained on the inside face of back panel 320, the lower left corner 350b of insert sheet 350 extends through notch 342 and contacts the outside face of back panel 320.

Notch 344 is formed from a convex die cut positioned in the right central portion of back panel 320—i.e., notch 344 is positioned adjacent the right side edge of back panel 320 and is substantially centered between the top and bottom edges of back panel 320. Notch 344 has a crescent or arc shape so as to form a tab 346 in back panel 320 (although other suitable shapes may also be used, such as triangular or rectangular). When insert sheet 350 is retained on the inside face of back panel 320, the right central portion 350c of insert sheet 350 extends underneath and engages tab 346, as shown in FIG. 3B.

It can be appreciated that insert sheet 350 is releasably retained by notches 340, 342 and 344 in a predetermined position on the inside face of back panel 320 so that the personalized or customized message on insert sheet 350 is exposed when card 300 is moved to its opened position.

FIGS. 3C-3G show various embodiments of greeting cards in which the number and position of the notches (each of which comprises either an oblong aperture or tab, as described above) are different than those of the card shown in FIGS. 3A-3B. In each of these drawings, it can be seen that the card is shown in an opened position with the outside faces of the front and back panels facing upward.

In FIG. 3C, the greeting card includes four notches 360, 362, 364 and 366 (each of which comprises an oblong aperture) formed in the four corners of the back panel for releasably retaining the corresponding corners of an insert sheet.

In FIG. 3D, the greeting card includes two notches 368 and 370 (each of which comprises an oblong aperture) formed in the top right and lower left corners of the back panel for releasably retaining the corresponding corners of an insert sheet.

In FIG. 3E, the greeting card includes two notches 372 and 374 (each of which comprises an oblong aperture) formed in the two lower corners of the back panel for releasably retaining the corresponding corners of an insert sheet.

In FIG. 3F, the greeting card includes two notches 376 and 378 (each of which comprises an oblong aperture) formed in the upper and lower right corners of the back panel for releasably retaining the corresponding corners of an insert sheet. It can be appreciated that the insert sheet is also captured by the fold line of the card to keep it in place.

In FIG. 3G, the greeting card includes one notch 380 (a tab) formed in the right central portion of the back panel for releasably retaining the corresponding portion of an insert sheet. It can be appreciated that the insert sheet is also captured by the fold line of the card to keep it in place.

While each of the greeting cards shown in FIGS. 3A-3G include one or more notches formed in the back panel of the card, it should be understood that any of these notch configurations could alternatively be provided on the middle panel of a three-panel card so that the notches cannot be seen from the back of the card. Of course, other card configurations with a notch format will be apparent to one skilled in the art.

Cards with Partial Pocket Format

Referring to FIGS. 4A-4E and FIG. 5, various embodiments of greeting cards with a partial pocket format for retaining an insert sheet in the card are shown. Each of these cards includes a partial pocket for releasably retaining a portion of an insert sheet in the pocket. In some embodiments, the lower portion of the insert sheet is releasably retained in the partial pocket of the card (as shown in FIGS. 4A-4E). In other embodiments, the left side portion of the insert sheet is releasably retained in the partial pocket of the card (as shown in FIG. 5). It will be seen that the configuration and construction of the partial pocket of the card is different between the various embodiments described below.

FIG. 4A show an embodiment of a card 400 with a front panel 410 and a back panel 420 that are movable relative to each other along a fold line 430—i.e., card 400 has substantially the same configuration as greeting card 100 described above. In this embodiment, card 400 also includes a pocket portion 440 attached to the inside face of back panel 420 so as to form a partial pocket for releasably retaining the lower portion of insert sheet 450 therein.

FIGS. 4B-4E show various embodiments of greeting cards in which the partial pocket of the card is constructed in different ways.

In FIG. 4B, the partial pocket has a one-piece construction in which a pocket portion folds from the bottom edge of the back panel onto the back side of the back panel (as illustrated). The pocket portion includes a pocket body 460 and two foldable flaps 462 and 464. Flaps 462 and 464 are glued on their front sides (as illustrated) and are folded so that the glue contacts corresponding glue lines 466 and 468, respectively, provided on the back side of the back panel (as illustrated). It should be understood that the terms “glue,” “glued,” “glue line” and similar terms as used herein is intended to encompass the use of any type of adhesive that is capable of securing two components together. When assembled, pocket body 460 and the back side of the back panel (as illustrated)—a portion of which is now covered by flaps 462 and 464—form a partial pocket for releasably retaining the lower portion of insert sheet 450 therein.

When assembled, the top edge of flap 462 is provided at a first angle (labeled as Angle A), the top edge of pocket body 460 is provided at a second angle (labeled as Angle B), and the top edge of flap 464 is provided at a third angle (labeled as Angle C). Angle B is selected so that the top edge of pocket body 460 is provided at a slant to enable easier insertion of insert sheet 450 into the partial pocket. For example, Angle B may have any value greater than 0 degrees and less than 20 degrees. Angle A is selected to be at least 5 degrees greater than Angle B so that (i) flap 462 is less visible when glued to the back side of the back panel (as illustrated) and (ii) the top edge of flap 462 is less likely to become a catch point when insert sheet 450 is guided into the partial pocket. Angle C is selected to be about 0 degrees (i.e., the upper edge of flap 464 is generally horizontal) so that (i) flap 464 is less visible when glued to the back side of the back panel (as illustrated) and (ii) the top edge of flap 464 is less likely to become a catch point when insert sheet 450 is guided into the partial pocket. Of course, Angle C could alternatively have a value that is about five degrees less than Angle B (to keep flap 464 hidden).

The partial pocket shown in FIG. 4B includes a number of other features that enable insert sheet 450 to be easily inserted into the partial pocket and/or that improve the aesthetic of the partial pocket when fully assembled. First, the fold line between the front and back panels of the card is preferably a crease score (not a cut score) so that the partial pocket does not lay too flat. It can be appreciated that a slight bulge in the partial pocket will make it easier to guide insert sheet 450 into the partial pocket. Second, the width of the partial pocket is at least 3 millimeters less than the width of the back panel in order to reduce bulk in the crease score area, which allows the card to lay flatter when fully assembled. Third, the distance between flaps 462 and 464 when glued to the back side of the back panel (as illustrated) is less than the width of insert sheet 450 and, as such, insert sheet 450 will not encounter any catch points along the vertical edges of flaps 462 and 464 when inserted into the partial pocket.

In FIG. 4C, the partial pocket has a one-piece construction in which a pocket portion folds from the left side edge of the back panel (as illustrated) onto the back side of the back panel (as illustrated). As shown, the pocket portion includes a pocket body 470 and two foldable flaps 472 and 474. Flaps 472 and 474 are glued on their front sides (as illustrated) and are folded so that the glue contacts corresponding glue lines 476 and 478, respectively, provided on the back side of the back panel (as illustrated). When assembled, pocket body 470 and the back side of the back panel (as illustrated)—a portion of which is now covered by flaps 472 and 474—form a partial pocket for releasably retaining the lower portion of insert sheet 450 therein.

When assembled, the top edge of flap 472 is provided at a first angle (labeled as Angle A) and the top edge of pocket body 470 is provided at a second angle (Angle B). Angle B is selected so that the top edge of pocket body 470 is provided at a slant to enable easier insertion of insert sheet 450 into the partial pocket. For example, Angle B may have any value greater than 0 degrees and less than 20 degrees. Angle A is selected to be about 0 degrees (i.e., the upper edge of flap 472 is generally horizontal) so that (i) flap 472 is less visible when glued to the back side of the back panel (as illustrated) and (ii) the top edge of flap 472 is less likely to become a catch point when insert sheet 450 is guided into the partial pocket. Of course, Angle A could alternatively have a value that is about five degrees less than Angle B (to keep flap 472 hidden).

The partial pocket shown in FIG. 4C includes a number of other features that enable insert sheet 450 to be easily inserted into the partial pocket and/or that improve the aesthetic of the partial pocket when fully assembled. First, the fold line between the front and back panels of the card is preferably a crease score (not a cut score) so that the partial pocket does not lay too flat. It can be appreciated that a slight bulge in the partial pocket will make it easier to guide insert sheet 450 into the partial pocket. Second, the width of the partial pocket is at least 3 millimeters less than the width of the back panel in order to reduce bulk in the crease score area, which allows the card to lay flatter when fully assembled. Third, the distance between the crease score and flap 472 when glued to the back side of the back panel (as illustrated) is less than the width of insert sheet 450 and, as such, insert sheet 450 will not encounter any catch points along the vertical edge of flap 472 when inserted into the partial pocket.

It should be noted that the partial pocket shown in FIG. 4C results in more paper waste and requires longer glue lines than the partial pocket shown in FIG. 4B. Thus, the partial pocket shown in FIG. 4B is more efficient that the partial pocket shown in FIG. 4C.

In FIG. 4D, the partial pocket includes a pocket portion provided as a separate attachment for securement to the back side of the back panel (as illustrated). As shown, the pocket portion includes a pocket body 480 and three foldable flaps 482, 484 and 486. Flaps 482 and 484 are glued on their front sides (as illustrated) and are folded so that the glue contacts corresponding glue lines 488 and 490, respectively, provided on the back side of the back panel (as illustrated). Flap 486 is also glued on its front side (as illustrated) and is folded so that the glue contacts the back side of the back panel (as illustrated) along its bottom edge. When assembled, pocket body 480 and the back side of the back panel—a portion of which is now covered by flaps 482, 484 and 486—form a partial pocket for releasably retaining the lower portion of insert sheet 450 therein.

When assembled, the top edge of flap 484 is provided at a first angle (labeled as Angle A), the top edge of pocket body 480 is provided at a second angle (labeled as Angle B), and the top edge of flap 482 is provided at a third angle (labeled as Angle C). Angle B is selected so that the top edge of pocket body 480 is provided at a slant to enable easier insertion of insert sheet 450 into the partial pocket. For example, Angle B may have any value greater than 0 degrees and less than 20 degrees. Angle A is selected to be at least 5 degrees greater than Angle B so that (i) flap 484 is less visible when glued to the back side of the back panel (as illustrated) and (ii) the top edge of flap 484 is less likely to become a catch point when insert sheet 450 is guided into the partial pocket. Angle C is selected to be about 0 degrees (i.e., the upper edge of flap 482 is generally horizontal) so that (i) flap 482 is less visible when glued to the back side of the back panel (as illustrated) and (ii) the top edge of flap 482 is less likely to become a catch point when insert sheet 450 is guided into the partial pocket. Of course, Angle C could alternatively have a value that is about five degrees less than Angle B (to keep flap 482 hidden).

The partial pocket shown in FIG. 4D includes a number of other features that enable insert sheet 450 to be easily inserted into the partial pocket and/or that improve the aesthetic of the partial pocket when fully assembled. First, the fold line between the front and back panels of the card is preferably a crease score (not a cut score) so that the partial pocket does not lay too flat. It can be appreciated that a slight bulge in the partial pocket will make it easier to guide insert sheet 450 into the partial pocket. Second, the width of the partial pocket is at least 3 millimeters less that the width of the back panel in order to reduce bulk in the crease score area, which allows the card to lay flatter when fully assembled. Third, the distance between flaps 482 and 484 when glued to the back side of the back panel (as illustrated) is less than the width of insert sheet 450 and, as such, insert sheet 450 will not encounter any catch points along the vertical edges of flaps 482 and 484 when inserted into the partial pocket.

It can be appreciated that the pocket portion shown in FIG. 4D may be configured to have any desired width and height (provided the dimensions are smaller than those of the back panel) and may be positioned anywhere on the inside face of the back panel. As such, this embodiment may be used to accommodate insert sheets having different sizes.

In FIG. 4E, the partial pocket includes a pocket portion formed from two panels i.e., the card includes panels 420a and 420b that together form the back panel. As shown, panel 420a includes an angled slot 492 that is formed from a die cut in panel 420a. Panel 420b includes a foldable flap 496 that is glued on its back side (as illustrated) and is folded so that the glue contacts a corresponding glue line 494 provided on the front side of panel 420a (as illustrated) when panel 420b is folded and tipped to the front of panel 420a. When assembled, panels 420a and 420b form a partial pocket for releasably retaining the lower portion of insert sheet 450 therein. It can be appreciated that insert sheet 450 may be inserted into the partial pocket through angled slot 492. Angled slot 492 has a width that is at least 6 millimeters wider than the thickness of insert sheet 450 for ease of insertion. It should be noted that there is a drop out line 498 below which no glue should be placed so as not to obstruct the insertion of insert sheet 450.

In the embodiments shown in FIGS. 4A-4E, it can be appreciated that the lower portion of insert sheet 450 is positioned within the partial pocket. As such, any portion of the customized or personalized message that has been printed on the lower portion of insert sheet 450 cannot be read by the card recipient without removing insert sheet 450 from the partial pocket. Alternatively, the print area for the customized or personalized message may be restricted to the upper portion of insert sheet 450 so that the message can be read by the card recipient without removal of insert sheet 450 from the partial pocket.

FIG. 5 show an embodiment of a card 500 with a front panel 510 and a back panel 520 that are movable relative to each other along a fold line 530. Card 500 also includes a pocket portion 540 attached to the inside face of back panel 520 so as to form a partial pocket for releasably retaining the left side portion of insert sheet 550 therein. One skilled in the art will appreciate that pocket portion 540 may be configured using construction techniques that are similar to those described above in connection with FIGS. 4B-4D. For example, pocket portion 540 may be provided as a separate attachment for securement to the inside face of back panel 520. In this embodiment, a pop-up structure 560 is secured to the inside face of front panel 510 and to pocket portion 540 and opens or “pops up” when greeting card 500 is moved to the opened position. Of course, other embodiments may not include a pop-up structure at all.

In this embodiment, it can be appreciated that the left side portion of insert sheet 550 is positioned within the partial pocket. As such, any portion of the customized or personalized message that has been printed on the left side portion of insert sheet 550 cannot be read by the card recipient without removing insert sheet 550 from the partial pocket. In other embodiments, the print area for the customized or personalized message is restricted to the right side portion of insert sheet 550 so that the message can be read by the card recipient without removal of insert sheet 550 from the partial pocket. In yet other embodiments, a design element (e.g., graphics) is pre-printed on the right side portion of insert sheet 550, while the customized or personalized message is printed on the left side portion so as to be positioned with the partial pocket. Further, it should be understood that the width of pocket portion 540 may be adjusted as desired for a particular implementation.

Cards with Frame Format

Referring to FIGS. 6A-6B, an embodiment of a greeting card with a frame format for retaining an insert sheet in the card is shown. FIG. 6A shows the card 600 with a front panel 610 and a back panel 620 that are movable relative to each other along a fold line 630. As shown in FIG. 6B, back panel 620 is formed from two panels—panels 620a and 620b. Panel 620a is configured as a frame—i.e., a rectangular shaped portion of the panel has been die cut and removed from the panel so as to form a central window. In contrast, panel 620b comprises a solid panel. Card 600 also includes a U-shaped spacer 660 having a base portion and two outwardly extending legs. Spacer 660 is glued on both sides and tips from the bottom edge of panel 620a so that the glue on the front side of spacer 660 (as illustrated) contacts corresponding glue lines 662 provided on the front side of panel 620a (as illustrated). Once spacer 660 is tipped and glued to panel 620a, panel 620b is then folded so that its glue lines 664 contact the glue on the back side of spacer 660 (as illustrated). When assembled, panels 620a and 620 define a pocket for receiving insert sheet 650 therein. Insert sheet 650 may be loaded into the pocket through the top of the back panel and retained between panels 620a and 620b so that the customized or personalized message appears through the central window of panel 620a. It can be appreciated that spacer 660 is configured to center insert sheet 650 in the pocket between panels 620a and 620b. Because the card is a top-loading card in which only the top edge of the pocket formed by panels 620a and 620b is open (i.e., the bottom and side edges are secured together either integrally or via adhesive), insert sheet 650 cannot fall out of the bottom of the pocket or either side of the pocket so as to secure insert sheet 650 in the pocket between panels 620a and 620b.

It should be understood that other embodiments of greeting cards with a frame format may be provided in accordance with the present invention. For example, a card may have the configuration of card 600 shown in FIGS. 6A-6B, but wherein the spacer is provided as a separate part (rather than being integrally formed with panel 620a). Also, a card may be provided in a disassembled state (as shown in FIG. 6B) so that a user can place insert sheet 650 face down on panel 620a, tip spacer 660 into place, and then fold panel 620b onto spacer 660. This option would eliminate the need for the user to feed insert sheet 650 into the pocket through the top of the back panel. In this case, the glue provided on the various parts may be in the form of double-sided tape to simply the assembly process. The configuration of spacer 660 may also be simplified, e.g., the base portion of spacer 660 may provide the desired spacing such that the legs are not required.

It should also be understood that the frame portion of panel 620a may have other configurations in accordance with the present invention. For example, the dimensions of the frame borders may be greater or less than those illustrated in FIGS. 6A-6B. Also, the portion of panel 620a that is die cut and removed from the panel may have a shape other than rectangular—e.g., the removed portion may be square, oval, circular, or any other desired shape. Also, the frame portion may be designed so that the inside edges of the frame are not straight line die cuts—e.g., the inside edges could be any type of zigzag, wavy or other decorative line in order to change the appearance of the frame portion. If decorative die cut lines are used, the bottom inside edge of the frame preferably has a simple design so that it does not create catch points when insert sheet 650 is loaded into the pocket through the top of the back panel and retained between panels 620a and 620b. It can be appreciated that the size and configuration of the frame panel will impact the portion of insert sheet 650 that can be viewed when inserted behind the frame panel. In particular, a larger frame panel will reduce the portion of insert sheet 650 that can be used for printing a customized or personalized message.

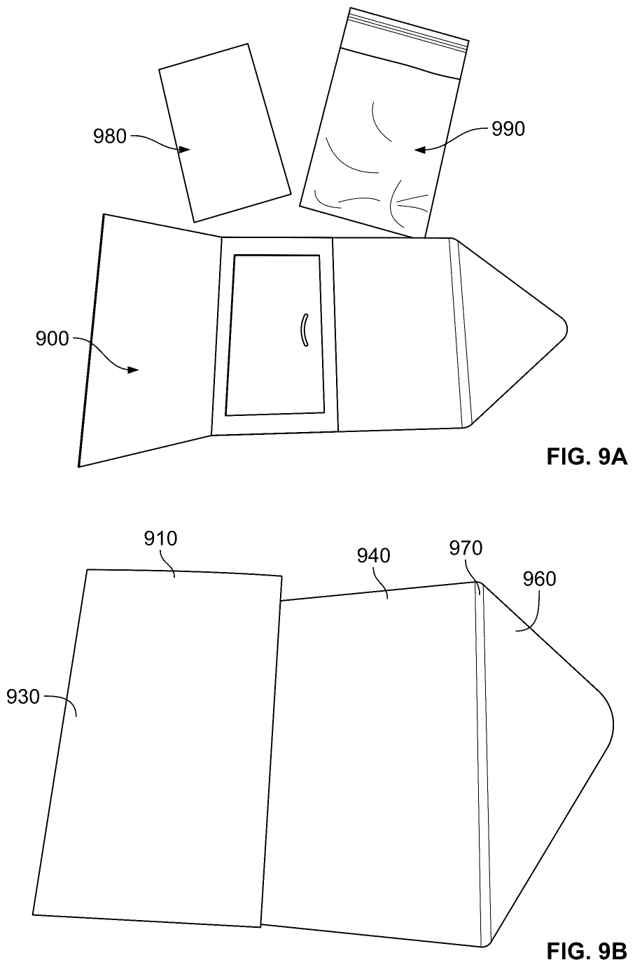

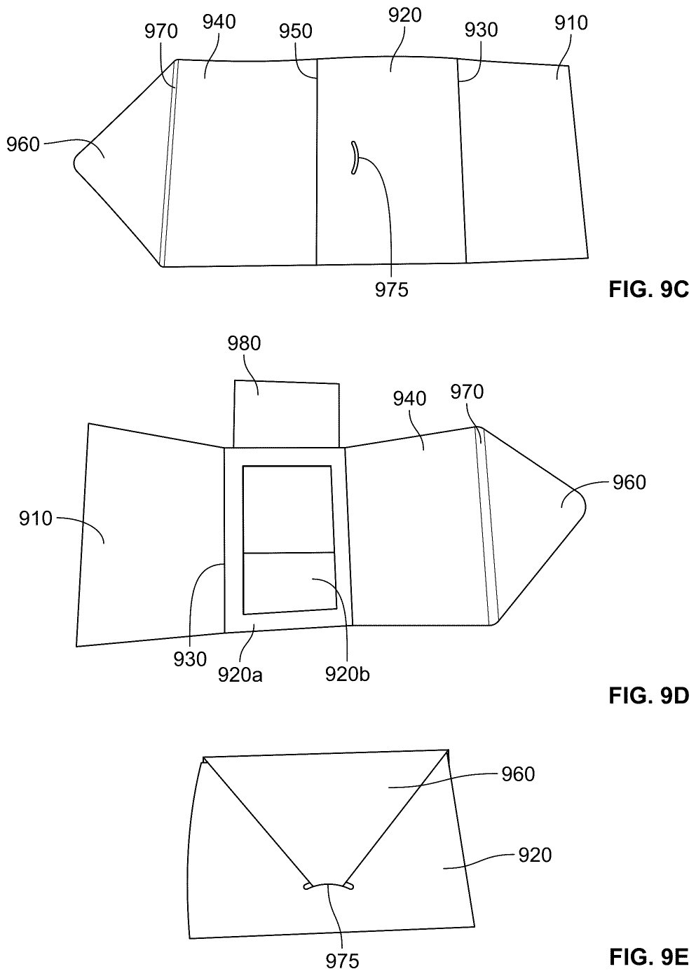

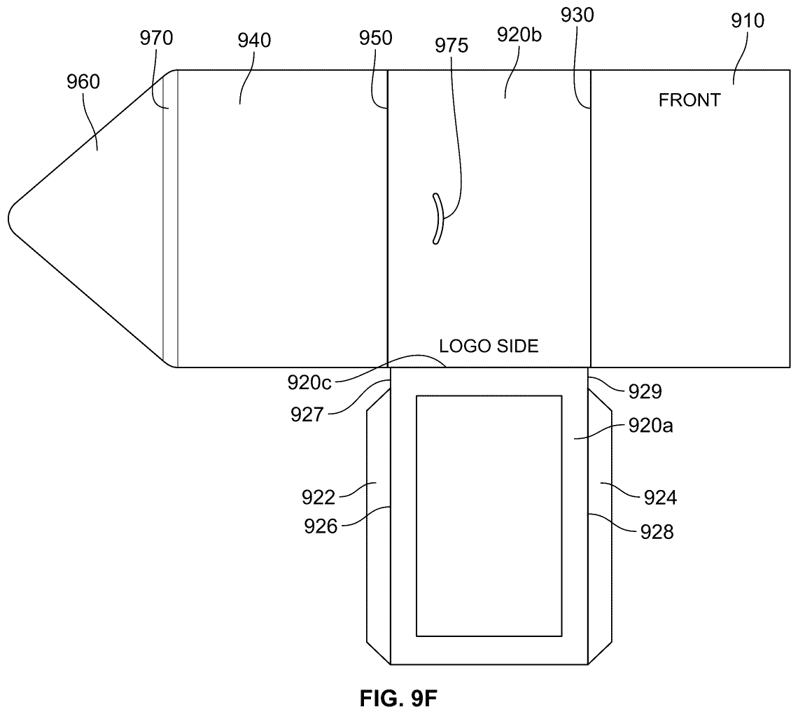

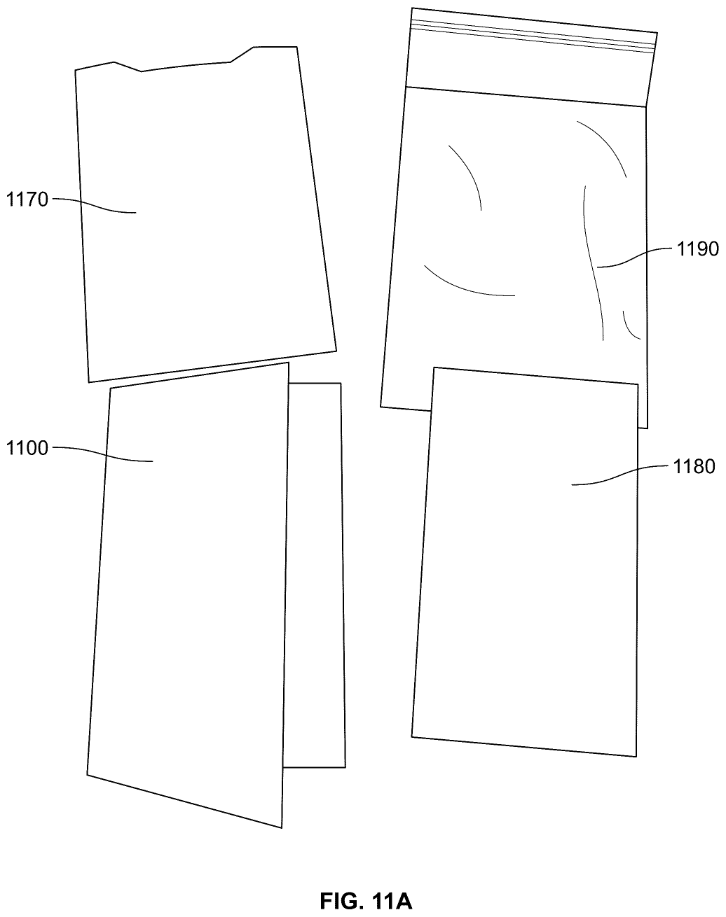

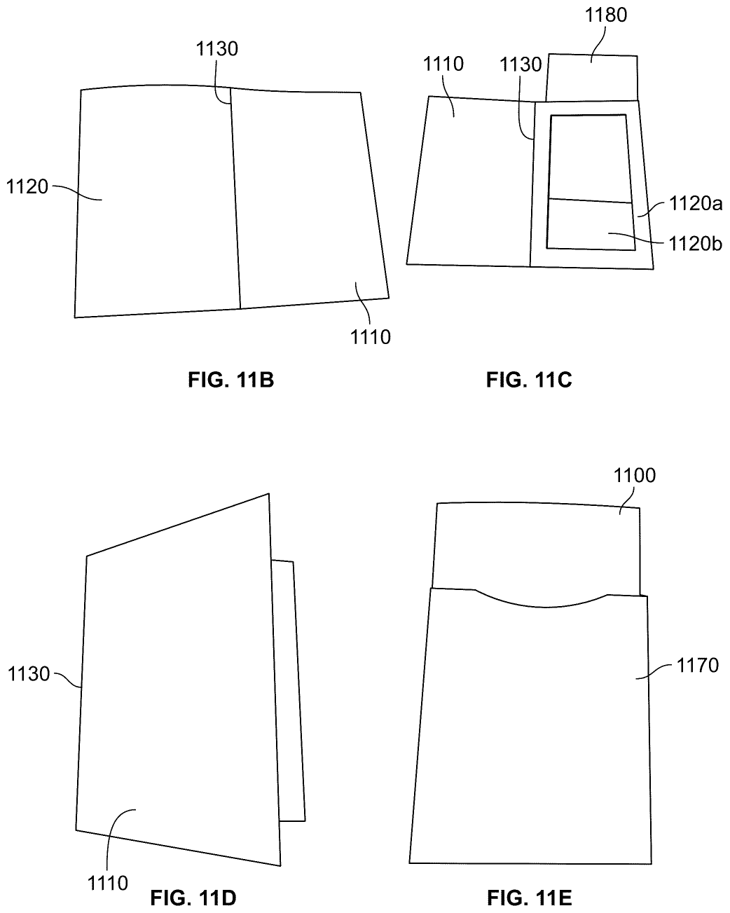

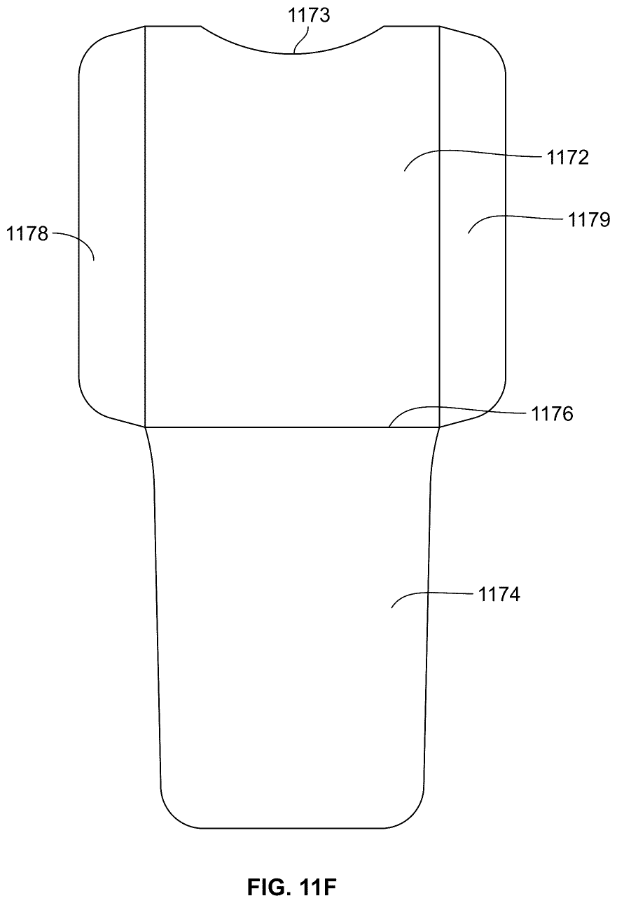

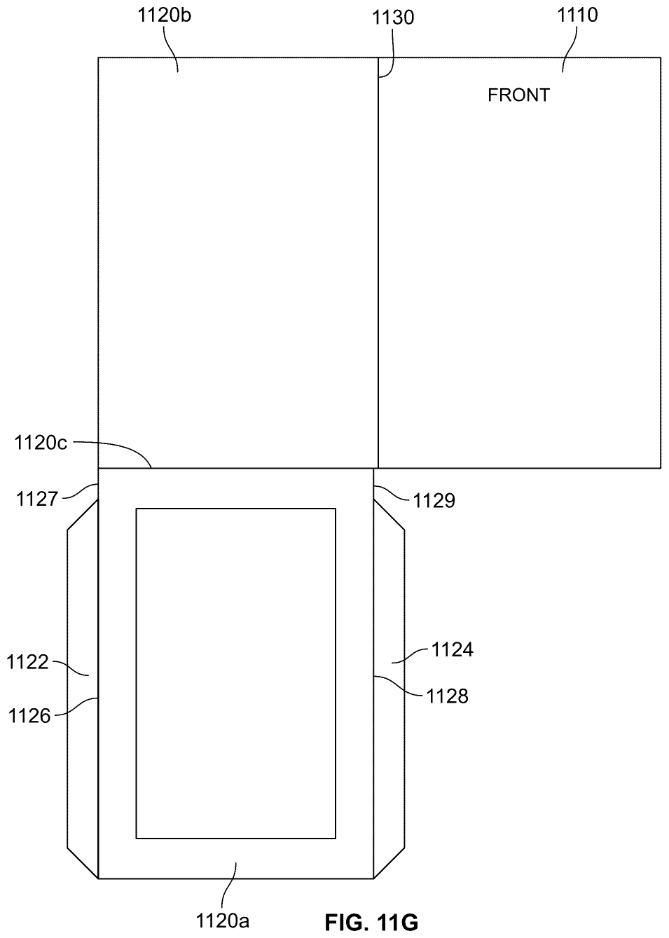

Other embodiments of greeting cards with a frame format will be described below in connection with FIGS. 9A-9F and 11A-11G. In each of these embodiments, the greeting card is part of a greeting card and envelope assembly, although one skilled in the art will appreciate that any of these greeting cards could be configured as a standalone greeting card that is provided without any type of envelope. Of course, other implementations will be apparent to one skilled in the art.

Cards with Hidden Pocket Format

Referring to FIGS. 7A-7B and FIGS. 8A-8B, various embodiments of greeting cards with a hidden pocket format for retaining an insert sheet in the card are shown. Each of these cards includes a hidden pocket formed by two card panels for releasably retaining an insert sheet inside the pocket. In some embodiments, the hidden pocket is accessed from the right side of the panels (as shown in FIGS. 7A-7B). In other embodiments, the hidden pocket is accessed from the left side of the panels (as shown in FIGS. 8A-8B). It will be seen that the configuration and construction of the hidden pocket is different between the various embodiments described below.

FIG. 7A shows an embodiment of a card 700 with a front panel 710 and a back panel 720 that are movable relative to each other along a fold line 730. As shown in FIG. 7B, back panel 720 is formed from two panels—panels 720a and 720b—wherein panel 720a folds from the top edge of panel 720b onto the front side of panel 720b (as illustrated). Panel 720a includes foldable flaps 760 that are glued on both sides. Flaps 760 are folded so that the glue on the front side (as illustrated) contacts the front side of panel 720a (as illustrated). Then, panel 720a is folded and tipped to the front side of panel 720b (as illustrated) so that the glue on the back side of flaps 760 (as illustrated) contacts corresponding glue lines 762 provided on the front side of panel 720b (as illustrated). When assembled, panels 720a and 720b form a hidden pocket for releasably retaining insert sheet 750 therein. As shown in FIG. 7A, insert sheet 750 may be inserted into the hidden pocket through the right side of back panel 720 and retained between panels 720a and 720b.

With reference to FIG. 7A, unlike the other card embodiments described above, the inside face of back panel 720 (which is actually the back side of panel 720b as illustrated in FIG. 7B) does not include any portion of a retention means. Thus, the inside face of back panel 720 may include pre-printed text, images, and/or graphics—similar to the sentiment provided on a conventional greeting card.

The hidden pocket shown in FIGS. 7A-7B includes a number of features that enable insert sheet 750 to be easily inserted into the pocket. First, an offset finger notch 764 is formed on the right side edge of panel 720b (the left side edge as illustrated in FIG. 7B) to allow easy insertion and removal of insert sheet 750 by the card recipient. It should be noted that panel 720a does not include such a notch so that the card recipient can place insert sheet 750 against the portion of panel 720b adjacent notch 764 during insertion. Second, the height of the hidden pocket is at least ¼ inch larger than the height of insert sheet 750 to provide sufficient space to guide insert sheet 750 into and out of the hidden pocket. Third, it can be appreciated that flaps 760 of panel 720a (when glued to glue lines 762 of panel 720b) serve as stops for insert sheet 450 on the inside of the hidden pocket. The dimensions of flaps 760 can be sized to provide optimal placement of insert sheet 750 in the hidden pocket—e.g., the placement of insert sheet 750 may be controlled so that the right side edge of insert sheet 750 is still visible to the card recipient when placed in the hidden pocket.

FIG. 8A shows an embodiment of a card 800 with a front panel 810 and a back panel 820 that are movable relative to each other along a fold line 830. As shown in FIG. 8B, back panel 820 is formed from two panels—panels 820a and 820b—wherein panel 820a folds from the top edge of panel 820b onto the back side of panel 820b (as illustrated). Panel 820b includes foldable flaps 860 that are glued on both sides. Flaps 860 are folded so that the glue on the back side (as illustrated) contacts the corresponding glue lines 862 provided on the back side of panel 820b (as illustrated). Then, panel 820a is folded and tipped to the back side of panel 720b (as illustrated) so that the glue lines 864 provided on the back side of panel 820a (as illustrated) contact the glue on the front side of flaps 860 (as illustrated). When assembled, panels 820a and 820b form a hidden pocket for releasably retaining insert sheet 850 therein. As shown in FIG. 8A, insert sheet 850 may be inserted into the hidden pocket through the left side of back panel 820 and retained between panels 820a and 820b.

With reference to FIG. 8A, like greeting card 700, the inside face of back panel 820 (which is actually the front side of panel 820a as illustrated in FIG. 8B) does not include any portion of a retention means. Thus, the inside face of back panel 820 may include pre-printed text, images, and/or graphics—similar to the sentiment provided on a conventional greeting card.

The hidden pocket shown in FIGS. 8A-8B includes a number of features that enable insert sheet 850 to be easily inserted into the pocket. First, an offset finger notch 866 is formed on the left side edge of panel 820a (the right side edge as illustrated in FIG. 8B) to allow easy insertion and removal of insert sheet 850 by the card recipient. It should be noted that panel 820b does not include such a notch so that the card recipient can place insert sheet 850 against the portion of panel 820a adjacent the notch during insertion. Second, the height of the hidden pocket is at least ¼ inch larger than the height of insert sheet 850 to provide sufficient space to guide insert sheet 850 into and out of the hidden pocket. Third, it can be appreciated that flaps 860 of panel 820b (when glued to glue lines 864 of panel 820a) serve as stops for insert sheet 850 on the inside of the hidden pocket. The dimensions of flaps 860 can be sized to provide optimal placement of insert sheet 850 in the hidden pocket—e.g., the placement of insert sheet 850 may be controlled so that the left side edge of insert sheet 850 is still visible to the card recipient when placed in the hidden pocket.

### Greeting Card and Envelope Assembly/Protective Sleeve

In some embodiments, the greeting card is provided as part of a greeting card and envelope assembly. In one aspect, the greeting card is integrally formed with the envelope so as to provide a one-piece greeting card and envelope assembly (also referred to as a postalette). In another aspect, the greeting card and envelope are separate components so as to provide a two-piece greeting card and envelope assembly. The greeting card of the greeting card and envelope assembly may have a notched format, a partial pocket format, a frame format, or a hidden pocket format, as described herein.

In some embodiments, the greeting card and envelope assembly is placed in a protective sleeve, thereby protecting the card surface from being soiled by environmental and hygiene factors (e.g., dirt, grime, etc.) due to handling at a fulfillment center. As such, the greeting card is protected until it is placed into a package for delivery with the rest of the items in an order. In one aspect, the protective sleeve containing the greeting card and envelope assembly is dropped in a package for delivery. In another aspect, a bottom edge of the protective sleeve is opened to enable the greeting card and envelope assembly to pass through the bottom edge and drop into a package for delivery. While the protective sleeve will be described below in connection with a greeting card and envelope assembly, it should be understood that the protective sleeve could also be used to contain a greeting card that is provided without any type of envelope.

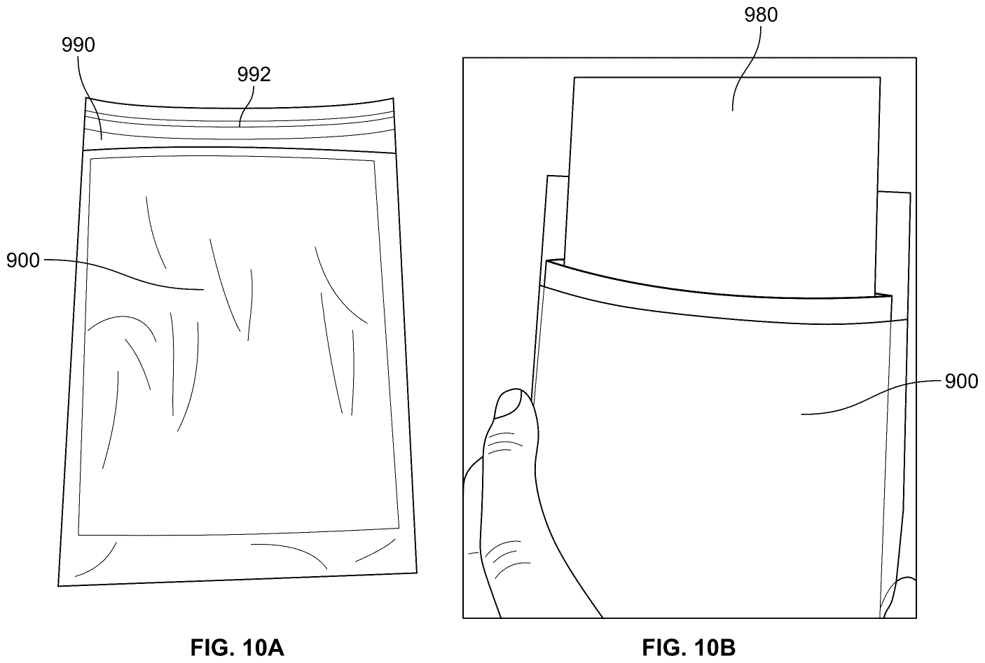

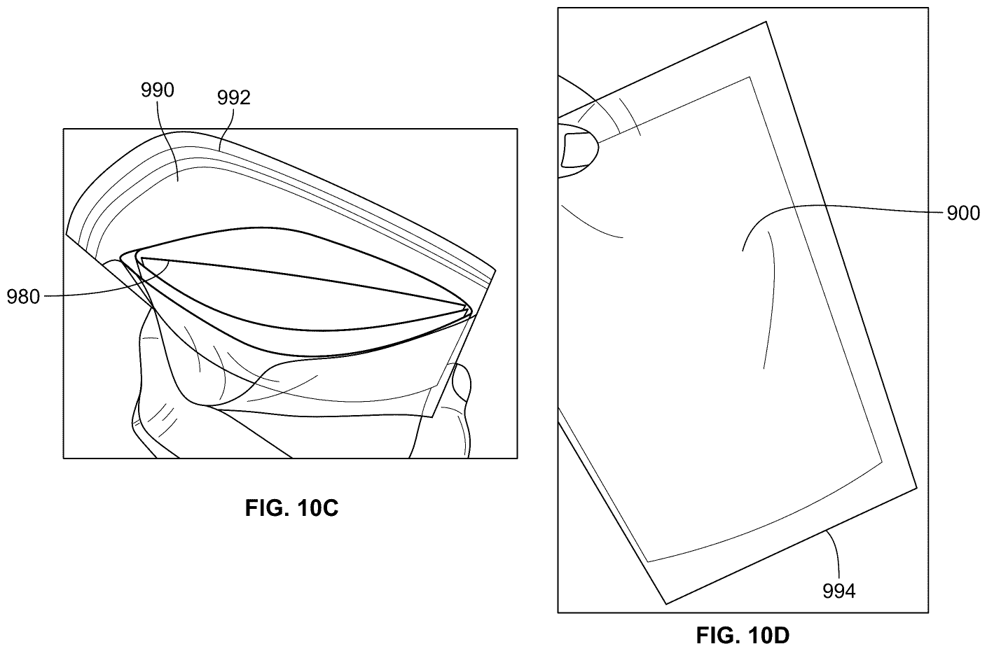

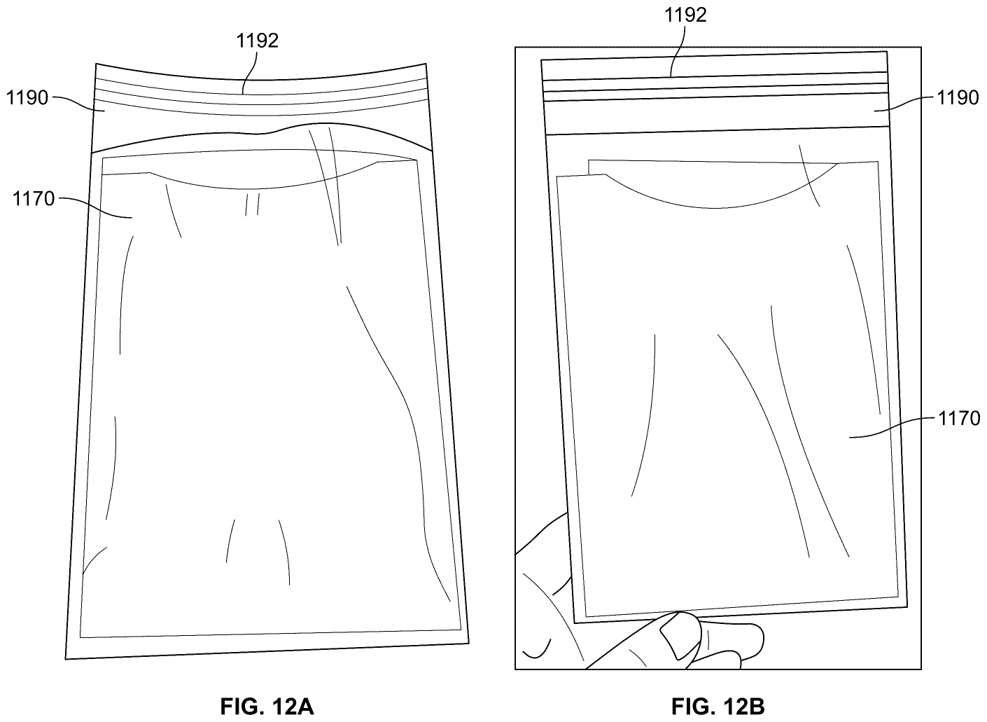

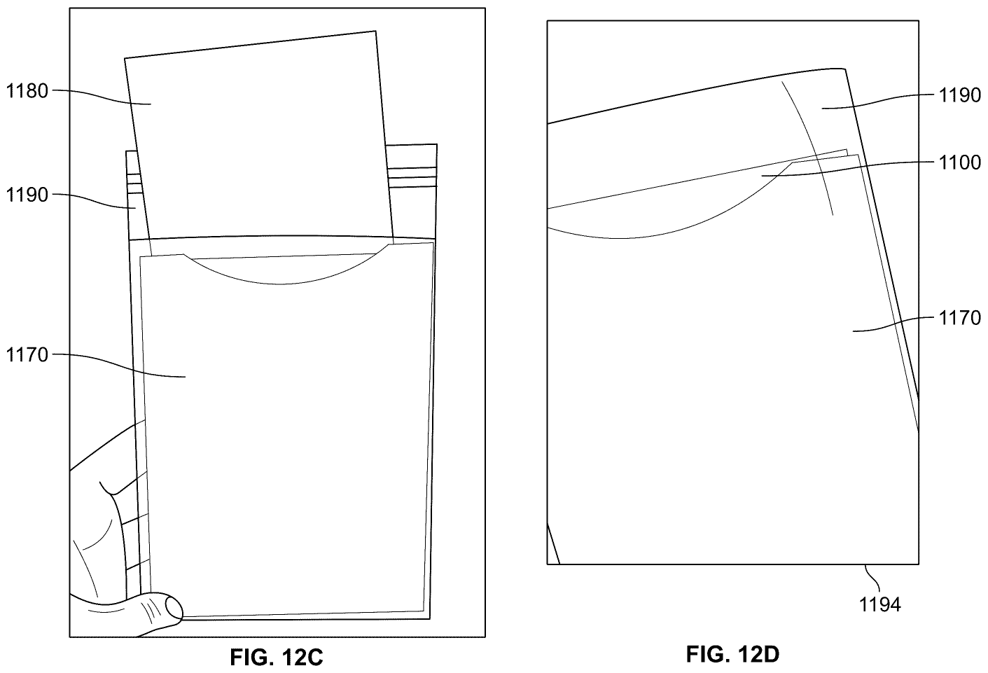

Various embodiments of a greeting card and envelope assembly provided in a protective sleeve will be described below. Specifically, FIGS. 9A-9F and 10A-10D show a one-piece greeting card and envelope assembly provided in a protective sleeve, and FIGS. 11A-11G and 12A-12D show a two-piece greeting card and envelope assembly provided in a protective sleeve. In each of these embodiments, the greeting card has a frame format for retaining an insert sheet in the card. Of course, it should be understood that the greeting card could have other formats in accordance with the present invention.

### One-Piece Card and Envelope Assembly Provided in Protective Sleeve

Referring to FIGS. 9A-9F, an embodiment of a one-piece greeting card and envelope assembly provided in a protective sleeve is shown. FIG. 9A shows the various components of this embodiment, including a card and envelope assembly 900, an insert sheet 980, and a protective sleeve 990. FIGS. 9B-9F show different views of the card and envelope assembly 900, as described below.

Greeting card and envelope assembly 900 includes a card portion with a front panel 910 a back panel 920 that are movable relative to each other along a fold line 930. As shown in FIG. 9F, back panel 920 is formed from two panels—panels 920a and 920b that are moveable relative to each other along a fold line 920c. Panel 920a is configured as a frame—i.e., a rectangular shaped portion of the panel has been die cut and removed from the panel so as to form a central window. In contrast, panel 920b comprises a solid panel. Panel 920a tips from the bottom edge of panel 920b and flaps 922 and 924 are folded along fold lines 926 and 928, respectively, and glued to the back side of panel 920b (as illustrated). When assembled, panels 920a and 920b define a pocket for receiving insert sheet 980 therein. As described below, insert sheet 980 may be loaded into the pocket through the top of the card and retained between panels 920a and 920b so that the customized or personalized message appears through the central window of panel 920a. It should be understood that insert sheet 980 is preferably undersized in relation to the pocket formed by panels 920a and 920b for ease of insertion. Because the card is a top-loading card in which only the top edge of the pocket formed by panels 920a and 920b is open (i.e., the bottom and side edges are secured together either integrally or via adhesive), insert sheet 980 cannot fall out of the bottom of the pocket or either side of the pocket so as to secure insert sheet 980 in the pocket between panels 920a and 920b.

The greeting card and envelope assembly 900 shown in FIG. 9F includes a number of features that improve the appearance or performance of the assembly and/or enable insert sheet 980 to be easily inserted into the pocket formed by panels 920a and 920b. First, the portion 927 of the left edge of panel 920a that is positioned above flap 922 (as illustrated) is not glued to provide relief at the bottom of the pocket so that insert sheet 980 can more easily be inserted all the way to the bottom of the pocket without pinching. Second, if decorative die cut lines are used for one or more inside edges of the frame, as described above in connection with greeting card 600 shown in FIGS. 6A-6B, the bottom inside edge preferably has a simple design so that it does not create catch points when insert sheet 980 is loaded into the pocket through the top of the back panel and retained between panels 920a and 920b. Third, the borders of the frame are preferably at least ½ inch to avoid bowing of the frame borders. Fourth, the fold line 930 between front panel 910 and panel 920b is preferably a crease score (not a cut score) to provide strength so that the score does not rip due to the stress of the bulk of folded paper on the inside of the card. Fifth, fold lines 926 and 928 are preferably crease scores (not cut scores) to avoid a “flash” of white paper that could adversely affect the appearance of darker colored printing. Sixth, the right side of panel 920a is held back at least 2 millimeters from the right side of panel 920b (as illustrated) (which can be particularly seen along the portion 929 of the right edge of panel 920a that is positioned above flap 924) to provide relief in the score area so that the card will fold flat.

Card and envelope assembly 900 also includes an envelope portion with an envelope panel 940 that is moveable relative to back panel 920 along a fold line 950. The envelope portion also include a flap 960 that is moveable relative to envelope panel 940 along a fold line 970. The envelope panel 940 may be folded onto the front panel 910 of the card portion, and then the tip of flap 960 may be inserted into a notch 975 formed in the back panel 920 (specifically, panel 920b) of the card portion in order to retain card and envelope assembly 900 in a closed position.

FIGS. 10A-10D illustrate an exemplary method for inserting an insert sheet 980 into a card and envelope assembly 900 that is provided in a protective sleeve 990 (which, in this embodiment, comprises a plastic bag). In FIG. 10A, the top edge 992 of the protective sleeve 990 is opened and the sides of card and envelope assembly 900 are gently squeezed in order to widen the opening and provide access to the inside of the card. In FIGS. 10B and 10C, the insert sheet 980 is loaded into the pocket through the top of the card and retained between panels 920a and 920b so that the customized or personalized message appears through the central window of panel 920a. At this point, the card and envelope assembly 900 with the insert sheet 980 retained therein is entirely contained in the protective sleeve 990. In FIG. 10D, the bottom edge 994 of the protective sleeve 990 is opened (e.g., by opening a flap) and the card and envelope assembly 900 with the insert sheet 980 retained therein passes through the bottom edge 994 and drops into a package for delivery. The protective sleeve 990 may then be discarded. Alternatively, the card and envelope assembly 900 with the insert sheet 980 retained therein may be provided in the protective sleeve 990 and dropped into a package for delivery (i.e., the step shown in FIG. 10D would not be performed).

### Two-Piece Card and Envelope Assembly Provided in Protective Sleeve

Referring to FIGS. 11A-11G, an embodiment of a two-piece greeting card and envelope assembly provided in a protective sleeve is shown. FIG. 11A shows the various components of this embodiment, including a greeting card 1100, a top-loading envelope 1170, an insert sheet 1180, and a protective sleeve 1190. FIGS. 11B-11G show different views of the greeting card 1100 and envelope 1170, as described below.

Greeting card 1100 includes a front panel 1110 a back panel 1120 that are movable relative to each other along a fold line 1130. As shown in FIG. 11G, back panel 1120 is formed from two panels—panels 1120a and 1120b that are moveable relative to each other along a fold line 1120c. Panel 1120a is configured as a frame—i.e., a rectangular shaped portion of the panel has been die cut and removed from the panel so as to form a central window. In contrast, panel 1120b comprises a solid panel. Panel 1120a tips from the bottom edge of panel 1120b and flaps 1122 and 1124 are folded along fold lines 1126 and 1128, respectively, and glued to the back side of panel 1120b (as illustrated). When assembled, panels 1120a and 1120 define a pocket for receiving insert sheet 1180 therein. As described below, insert sheet 1180 may be loaded into the pocket through the top of the card and retained between panels 1120a and 1120b so that the customized or personalized message appears through the central window of panel 1120a. It should be understood that insert sheet 1180 is preferably undersized in relation to the pocket formed by panels 1120a and 1120b for ease of insertion. Because the card is a top-loading card in which only the top edge of the pocket formed by panels 1120a and 1120b is open (i.e., the bottom and side edges are secured together either integrally or via adhesive), insert sheet 1180 cannot fall out of the bottom of the pocket or either side of the pocket so as to secure insert sheet 1180 in the pocket between panels 1120a and 1120b.

The greeting card 1100 shown in FIG. 11G includes a number of features that improve the appearance or performance of the card and/or enable insert sheet 1180 to be easily inserted into the pocket formed by panels 1120a and 1120b. First, the portion 1127 of the left edge of panel 1120a that is positioned above flap 1122 (as illustrated) is not glued to provide relief at the bottom of the pocket so that insert sheet 1180 can more easily be inserted all the way to the bottom of the pocket without pinching. Second, if decorative die cut lines are used for one or more inside edges of the frame, as described above in connection with greeting card 600 shown in FIGS. 6A-6B, the bottom inside edge preferably has a simple design so that it does not create catch points when insert sheet 1180 is loaded into the pocket through the top of the back panel and retained between panels 1120a and 1120b. Third, the borders of the frame are preferably at least ½ inch to avoid bowing of the frame borders. Fourth, the fold line 1130 between front panel 1110 and panel 1120b is preferably a crease score (not a cut score) to provide strength so that the score does not rip due to the stress of the bulk of folded paper on the inside of the card. Fifth, fold lines 1126 and 1128 are preferably crease scores (not cut scores) to avoid a “flash” of white paper that could adversely affect the appearance of darker colored printing. Sixth, the right side of panel 1120a is held back at least 2 millimeters from the right side of panel 1120b (as illustrated) (which can be particularly seen along the portion 1129 of the right edge of panel 1120a that is positioned above flap 1124) to provide relief in the score area so that the card will fold flat.

As shown in FIG. 11F, envelope 1170 includes a front panel 1172 and a back panel 1174 that are movable relative to each other along a fold line 1176. The back panel 1174 tips from the bottom edge of the front panel 1172, and then side flaps 1178 and 1179 of the front panel 1172 are folded and glued to the front side of the back panel 1174 (as illustrated). It can be appreciated that the top edge of the envelope 1170 is open to enable insertion of greeting card 1100 therein. In this embodiment, front panel 1172 includes a curved section 1173 that is centrally located along its top edge that enables the card recipient to more easily remove greeting card 1100 from envelope 1170. The curvature of curved section 1173 may be modified to be more decorative as desired for a particular implementation. Envelope 1170 is preferably made of a lightweight envelope paper (similar to conventional greeting card envelopes), but could alternatively be made of a heavier stock weight for more stability.

FIGS. 12A-12D illustrate an exemplary method for inserting an insert sheet 1180 into a greeting card 1100 that has been inserted into an envelope 1170 and provided in a protective sleeve 990 (which, in this embodiment, comprises a plastic bag). In FIG. 12A, the top edge 1192 of the protective sleeve 1190 is opened and the sides of the card and envelope assembly are gently squeezed in order to widen the opening and provide access to the inside of the card. In FIGS. 12B and 12C, the insert sheet 1180 is loaded into the pocket through the top of the greeting card 1100 and retained between panels 1120a and 1120b so that the customized or personalized message appears through the central window of panel 1120a. At this point, the card and envelope assembly with the insert sheet 1180 retained therein is entirely contained in the protective sleeve 1190. In FIG. 12D, the bottom edge 1194 of the protective sleeve 1190 is opened (e.g., by opening a flap) and the card and envelope assembly with the insert sheet 1180 retained therein passes through the bottom edge 1194 and drops into a package for delivery. The protective sleeve 1190 may then be discarded. Alternatively, the card and envelope assembly with the insert sheet 1180 retained therein may be provided in the protective sleeve 1190 and dropped into a package for delivery (i.e., the step shown in FIG. 12D would not be performed).

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

Finally, while the present invention has been described and illustrated hereinabove with reference to various exemplary embodiments, it should be understood that various modifications could be made to these embodiments without departing from the scope of the invention. Therefore, the present invention is not to be limited to the specific structural configurations or methodologies of the exemplary embodiments, except insofar as such limitations are included in the following claims.

What is claimed and desired to be secured by Letters Patent is as follows:

1. A greeting card for retaining an insert sheet bearing a personalized or customized message, comprising:
a front panel; and
a back panel comprising a frame panel secured to a solid panel, wherein the frame panel and the solid panel define a pocket for retaining the insert sheet between the frame panel and the solid panel.

2. The greeting card of claim 1, wherein the frame panel and the solid panel are not secured together along their respective top edges so as to form a top-loading pocket that enables loading of the insert sheet through a top of the pocket.

3. The greeting card of claim 2, wherein the frame panel and the solid panel are secured together along their respective bottom edges and their respective first and second side edges so as to contain the insert sheet within the pocket.

4. The greeting card of claim 3, wherein the bottom edge of the frame panel is integrally connected to the bottom edge of the solid panel via a fold line.

5. The greeting card of claim 3, wherein the first and second sides edges of the frame panel include first and second flaps, respectively, that are secured to the first and second side edges of the solid panel, respectively.

6. The greeting card of claim 1, wherein the frame panel defines a window, and wherein the insert sheet is retained between the frame panel and the solid panel so that the message is viewable through the window.

7. A greeting card for retaining an insert sheet bearing a personalized or customized message, comprising:
at least two card panels including a front panel and a back panel; and
retention means for releasably retaining the insert sheet between the front panel and the back panel.

8. The greeting card of claim 7, wherein the retention means comprises one or more notches formed in one of the card panels, wherein the notches are configured to releasably retain one or more of a corner and an edge portion of the insert sheet therein.

9. The greeting card of claim 7, wherein the retention means comprises a partial pocket configured to releasably retain a portion of the insert sheet therein.

10. The greeting card of claim 9, wherein the partial pocket is formed by one of the card panels and a pocket body secured thereto.

11. The greeting card of claim 9, wherein the partial pocket is formed between two of the card panels.

12. The greeting card of claim 7, wherein the retention means comprises a frame configured to releasably retain the insert sheet in a pocket.

13. The greeting card of claim 12, wherein the frame is formed by two of the card panels that define the pocket therebetween, wherein the card panels comprise a frame panel that forms the front of the frame and a solid panel that forms the back of the frame.

14. The greeting card of claim 7, wherein the retention means comprises a hidden pocket configured to releasably retain the insert sheet therein.

15. The greeting card of claim 14, wherein the hidden pocket is formed between two of the card panels.

16. A greeting card for retaining an insert sheet bearing a personalized or customized message, comprising:
a front panel; and
a back panel comprising a frame panel secured to a solid panel, wherein the frame panel defines a window, and wherein the frame panel and the solid panel define a top-loading pocket for retaining the insert sheet between the frame panel and the solid panel so that the message is viewable through the window.

17. The greeting card of claim 16, wherein the frame panel and the solid panel are not secured together along their respective top edges.

18. The greeting card of claim 17, wherein the frame panel and the solid panel are secured together along their respective bottom edges and their respective first and second side edges.

19. The greeting card of claim 18, wherein the bottom edge of the frame panel is integrally connected to the bottom edge of the solid panel via a fold line.

20. The greeting card of claim 18, wherein the first and second sides edges of the frame panel include first and second flaps, respectively, that are secured to the first and second side edges of the solid panel, respectively.
